(19) United States
(12) Patent Application Publication
(10) Pub. No.: US 2026/0348820 A1
(43) Pub. Date: Nov. 5, 2026

(54) LIPID BASED NANOPARTICLE CHARACTERIZATION

(71) Applicant: Beckman Coulter, Inc., Brea, CA (US)

(72) Inventors: Akash BHATTACHARYA, Loveland, CO (US); Emilie BOUDA, Indianapolis, IN (US); Shawn STERNISHA, Miami, FL (US); Ross VERHEUL, Indianapolis, IN (US); Shaofeng WANG, Woburn, MA (US)

(73) Assignee: Beckman Coulter, Inc., Brea, CA (US)

(21) Appl. No.: 19/140,032

(22) PCT Filed: Dec. 19, 2023
(86) PCT No.: PCT/US2023/084766

§ 371 Date: Jun. 17, 2025

Related U.S. Application Data
(60) Provisional application No. 63/476,048, filed on Dec. 19, 2022.

(51) Int. Cl. G01N 15/075; G01N 15/00; G01N 15/04

(52) U.S. Cl. CPC G01N 15/075; G01N 15/042; G01N 2015/0038; G01N 2015/045

(57) ABSTRACT

A method for density-based separation of lipid based nanoparticles by centrifugation includes receiving a container having a solution and lipid based nanoparticles. The method includes applying a centrifugal force to the container to cause the lipid based nanoparticles to displace and form at least one grouping within the container. The method includes measuring the position of the at least one detectable grouping of lipid based nanoparticles.

### CROSS-REFERENCE TO RELATED APPLICATION

This application is being filed on Dec. 19, 2023, as a PCT International application and claims priority to and the benefit of U.S. Provisional Application Ser. No. 63/476,048, filed Dec. 19, 2022, the disclosure of which is hereby incorporated by reference herein in its entirety.

### BACKGROUND

Lipid nanoparticles have emerged across the pharmaceutical industry as promising vehicles for delivery of a variety of therapeutics such as mRNA vaccines. Lipid nanoparticles play a key role in effectively protecting and transporting mRNA to cells. Lipid nanoparticles can be generated synthetically or can be derived from a biologic source. Illustrative examples of lipid nanoparticles include extracellular vesicles, which are small lipid enclosed carriers of bioactive proteins, lipids, and nucleic acids.

Lipid nanoparticles are made up of lipid layers or shells. For example, lipid nanoparticles can be made of bilayers of lipids which form spherical structures providing an interior space which can be loaded with a therapeutic payload.

Lipid nanoparticles can be loaded with a wide variety of therapeutic payloads such as messenger ribonucleic acid (mRNA), small interfering RNA (siRNA), plasmids, proteins and peptides, and small molecules. Characterizing lipid nanoparticles containing therapeutic payloads is a significant challenge.

### SUMMARY

In general terms, the present disclosure relates to analyzing nanoparticles, including a loading efficiency of such particles. In one possible configuration, lipid based nanoparticles are classified based on payload fullness. Various aspects are described in this disclosure, which include, but are not limited to, the following aspects.

One aspect relates to a system for analyzing a sample of lipid based nanoparticles designed for carrying a payload, the system comprising: a processing circuitry having one or more non-transitory computer readable storage media storing instructions which, when executed by the processing circuitry, cause the processing circuitry to: rotate a rotor holding at least one container, the at least one container having a density gradient forming material and the sample of lipid based nanoparticles; measure light absorption by the sample of lipid based nanoparticles in the at least one container while rotating the rotor; and assess a magnitude of the payload carried in the sample of lipid based nanoparticles based on the light absorption.

Another aspect relates to a method of analyzing a sample of lipid based nanoparticles carrying payloads, the method comprising: providing a density gradient forming material; operating a centrifuge to rotate a rotor about an axis of rotation at a preset rotor speed to form a density gradient in a container having the density gradient forming material and the sample of lipid based nanoparticles: measuring light absorption by the sample of lipid based nanoparticles in the container; and determining a ratio of the lipid based nanoparticles having a full payload versus an empty or partially full payload based on the light absorption.

Another aspect relates to a centrifuge for providing quality control of a sample of lipid based nanoparticles, the centrifuge comprising: a rotor for holding the sample of lipid based nanoparticles; an optical system for measuring light absorption by the sample of lipid based nanoparticles while the rotor rotates; and one or more non-transitory computer readable storage media programmed to analyze the light absorption of the sample of lipid based nanoparticles when the sample of lipid based nanoparticles is suspended in a density gradient.

Another aspect relates to a system for analyzing a sample of lipid based nanoparticles, the system comprising: a processing circuitry having one or more non-transitory computer readable storage media storing instructions which, when executed by the processing circuitry, cause the processing circuitry to: rotate a rotor about an axis of rotation at a preset rotor speed, the rotor holding at least one container having a density gradient forming material added to the sample of lipid based nanoparticles; measure light absorption by the sample of lipid based nanoparticles in the at least one container; and determine a ratio of the lipid based nanoparticles having a full payload versus an empty or partially full payload based on the light absorption.

Another aspect relates to a system for analyzing a sample of lipid based nanoparticles, the system comprising: a processing circuitry having one or more non-transitory computer readable storage media storing instructions which, when executed by the processing circuitry, cause the processing circuitry to: rotate a rotor holding at least one container, the at least one container having a density gradient forming material and the sample of lipid based nanoparticles; measure a density gradient in the at least on container; measure positions of the lipid based nanoparticles relative to the density gradient; and assess a magnitude of a payload of the lipid based nanoparticles based on the positions of the lipid based nanoparticles relative to the density gradient.

Another aspect relates to a method for density-based separation of lipid based nanoparticles by centrifugation, the method comprising: receiving a container having a solution and lipid based nanoparticles; applying a centrifugal force to the container to cause the lipid based nanoparticles to displace and form at least one detectable grouping within the container; and measuring the position of the at least one detectable grouping of lipid based nanoparticles.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### DESCRIPTION OF THE FIGURES

The following drawing figures, which form a part of this application, are illustrative of the described technology and are not meant to limit the scope of the disclosure in any manner.

FIG. 1 is a schematic block diagram of an example centrifuge that can be used to analyze lipid nanoparticles in accordance with the present disclosure.

FIG. 2 schematically illustrates an example of a kit that can be used for analyzing a sample of lipid nanoparticles using the centrifuge of FIG. 1.

FIG. 3 schematically illustrates an example of a method of operating the centrifuge of FIG. 1 to analyze lipid nanoparticles in accordance with the present disclosure.

FIG. 4 illustrates an example of a container with a density gradient solution added to a sample of lipid nanoparticles prior to centrifugation by the centrifuge of FIG. 1.

FIG. 5 illustrates an example of the container with the density gradient solution added to the sample of lipid nanoparticles after centrifugation by centrifuge of FIG. 1.

FIG. 6 illustrates another example of a rotor holding multiple containers having a density gradient solution added to a sample of lipid nanoparticles for centrifugation by the centrifuge of FIG. 1.

FIG. 7 illustrates a chart of theoretical data including light absorption measured from a container having a density gradient solution added to a sample of lipid nanoparticles during centrifugation by the centrifuge of FIG. 1.

FIG. 8a illustrates an example of a chart showing an effect of rotor speed on a density gradient formed by the centrifuge of FIG. 1.

FIG. 8b illustrates an example of a chart showing an effect of time on a density gradient formed by the centrifuge of FIG. 1.

FIG. 9 schematically illustrates an example of a method of classifying lipid nanoparticles that can be performed by the centrifuge of FIG. 1.

FIG. 10 schematically illustrates another example of a method of classifying lipid nanoparticles that can be performed using the centrifuge of FIG. 1.

FIG. 11 illustrates empirical data of light absorption measured across a length of a container during centrifugation by the centrifuge of FIG. 1.

FIG. 12 illustrates a portion of the empirical data from FIG. 11 that is measured toward an end of the experiment after equilibrium has been attained.

FIG. 13 illustrates empirical data of Rayleigh interference fringes (RIF) during centrifugation by the centrifuge of FIG. 1.

FIG. 14 illustrates a portion of the empirical data from FIG. 13 that is measured toward an end of the experiment after equilibrium has been attained.

FIG. 15 illustrates segmentation of the empirical data from FIG. 12.

FIG. 16 schematically illustrates an example of a method of processing the empirical data of FIG. 12 to assess a magnitude of payload carried in the sample of lipid nanoparticles based on the light absorption.

FIG. 17 illustrates processing of the empirical data from FIG. 12 into two discrete Gaussian curves by performance of the method of FIG. 16.

FIG. 18 illustrates processing of the empirical data from FIG. 12 into three discrete Gaussian curves by performance of the method of FIG. 16.

FIG. 19 illustrates processing of the empirical data from FIG. 12 into four discrete Gaussian curves by performance of the method of FIG. 16.

FIG. 20 illustrates processing of the empirical data from FIG. 12 into five discrete Gaussian curves by performance of the method of FIG. 16.

FIG. 21 schematically illustrates an example of a method of processing empirical data of FIGS. 24 and 28 to assess a magnitude of payload carried in a sample of liposomes based on light absorption at multiple wavelengths.

FIG. 22 illustrates empirical data of light absorption measured across a length of a container loaded with a sample of empty liposomes as well as loaded liposomes during centrifugation by the centrifuge of FIG. 1.

FIG. 23 illustrates a portion of the empirical data of FIG. 22 that is measured toward an end of the experiment after equilibrium has been attained.

FIG. 24 illustrates segmentation of the portion of the empirical data from FIG. 23.

FIGS. 25A and 25B illustrate performance of the operations of the method of FIG. 21 on the empirical data of FIG. 22.

FIG. 26. illustrates empirical data of light absorption measured across a length of a container loaded with a sample of empty liposomes as well as drug loaded liposomes during centrifugation by the centrifuge of FIG. 1.

FIG. 27 illustrates a portion of the empirical data of FIG. 26 that is measured toward an end of the experiment after equilibrium has been attained.

FIG. 28 illustrates segmentation of the portion of the empirical data from FIG. 27.

FIGS. 29A and 29B illustrates performance of the operations of the method of FIG. 21 on the empirical data of FIG. 26.

### DETAILED DESCRIPTION

Various embodiments will be described in detail with reference to the drawings, where like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Lipid nanoparticles exhibit characteristics that can vary greatly based on their composition and their payloads. This can make characterizing lipid nanoparticles more challenging than other types of particles such as adeno-associated viruses (AAVs). As used herein, payload can include one or more strands of mRNA, siRNA, plasmids, proteins and peptides, small molecules, and other materials.

The composition of lipid nanoparticles is significantly different from the composition of AAVs. For example, AAVs typically include a capsid or shell of protein that is loaded with a single stranded DNA (ssDNA). In contrast, lipid nanoparticles are made of lipids, and can be load with more than one item such as multiple strands of RNA.

AAVs are considered partially loaded when their capsids include an incomplete strand of the ssDNA. In contrast, lipid nanoparticles can contain several copies of RNA, but not enough to fill the entire interior space formed by the lipid shell. This can make characterizing lipid nanoparticles more challenging than other types of particles such as AAVs.

Lipid nanoparticles can be magnitudes larger than AAVs, and can vary widely in size from one lipid nanoparticle to the next. Also, since lipid nanoparticles can be loaded with varying amounts of payload (e.g., multiple strands of RNA), lipid nanoparticles can exhibit a wider range of densities than other types of particles such as AAVs. The variances in size and density present further challenges for analyzing and classifying lipid nanoparticles.

Additionally, lipid nanoparticles do not typically exhibit characteristic absorption wavelengths because they are not composed of a protein shell like AAVs. Instead, the ultraviolet (UV) absorption spectra exhibited by lipid nanoparticles is modulated by their payload, which can vary for the reasons discussed above. As an illustrative example, lipid nanoparticles having mRNA cargo can absorb at about 260 nm, while some small molecule drugs can absorb at higher wavelengths. This presents another challenge for analyzing and classifying lipid nanoparticles over other types of particles such as AAVs.

While the following description is described with reference to lipid nanoparticles, it is contemplated that the techniques described herein can be similarly applied to other type of lipid based nanoparticles. As used herein, lipid based nanoparticles can include m-RNA-carrying lipid nanoparticles, solid lipid nanoparticles, nanostructured lipid carriers, liposomes, drug-loaded liposomes, targeted liposomes, stealth liposomes, and cubosomes.

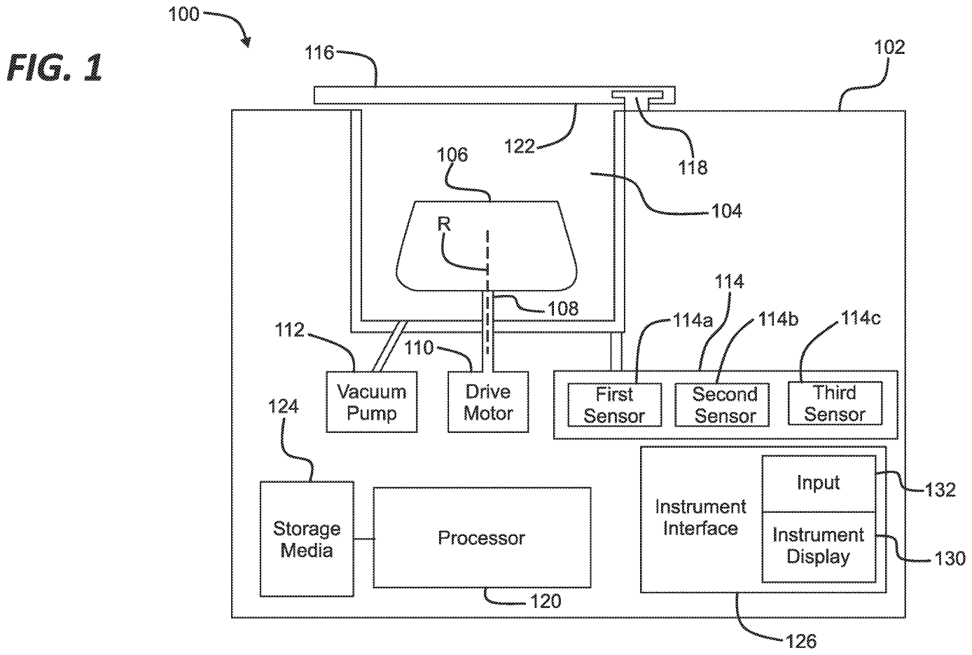

FIG. 1 is a schematic block diagram of an example centrifuge 100. As will be described in more detail, the centrifuge 100 can be used to analyze various types of particles including lipid nanoparticles containing payloads in accordance with the techniques described herein. The centrifuge 100 generates centrifugal forces to separate the particles mixed in a sample, while also measuring data from the particles during centrifugation. In the example illustrated in FIG. 1, the centrifuge 100 includes a housing 102, a rotor chamber 104, a rotor 106, a drive shaft 108, a motor 110, a processor 120, and an instrument interface 126.

The housing 102 protects and encloses at least some of the components of the centrifuge 100, such as the rotor 106. As shown in FIG. 1, the rotor 106 is arranged in the rotor chamber 104, and holds the samples. The rotor chamber 104 defines an interior space in which the rotor 106 spins. In the illustrated example, an opening 122 on top of the rotor chamber 104 provides a user access to the rotor 106. A door 116 covers the opening 122, and a latch 118 secures the door 116 in place. Preferably, the door 116 and the rotor chamber 104 are reinforced to contain energy and debris that may be released in the event of a rotor failure.

The drive shaft 108 extends into the rotor chamber 104 and releasably connects to the rotor 106. The releasable connection between the drive shaft 108 and the rotor 106 permits the rotor 106 to be removed from the rotor chamber 104, and facilitates using different rotors or replacing the rotors as desired. The motor 110 connects to the drive shaft 108, and rotates the rotor 106 at a predetermined speed about an axis of rotation R that is substantially parallel with the drive shaft 108. An example of a motor 110 is an AC induction motor, or other suitable drive mechanisms including, for example, switched reluctance drives.

In the example of FIG. 1, the centrifuge 100 includes a vacuum pump 112 to adjust the atmospheric pressure in the rotor chamber 104. The vacuum pump 112 is coupled to the rotor chamber 104 through a hose, tube, pipe, or the like, to withdraw air from the rotor chamber 104.

The centrifuge 100 includes an optical system 114 that measures data in real-time from the samples held by the rotor 106 during centrifugation. In some examples, the optical system 114 allows the centrifuge 100 to perform analytical ultracentrifugation (AUC), which is an analytical technique that combines optical monitoring with ultracentrifugation (i.e., centrifugal forces greater than 100,000×g). In some alternative examples, the centrifuge 100 can perform optical monitoring at lower speeds (e.g., centrifugal forces as low as 32,000×g).

The optical system 114 includes a first sensor 114a to detect light absorption by particles of interest contained in the samples held by the rotor 106. The particles of interest can include lipid nanoparticles having payloads such as multiple strands of mRNA. In some examples, depending on a density gradient media (e.g., iodixanol), the light absorbance can be used by the centrifuge 100 to measure a density gradient formed in the samples held by the rotor 106 during and/or after centrifugation.

The optical system 114 includes a second sensor 114b to detect light interference in the samples held by the rotor 106. In accordance with the examples provided below, the light interference can be used by the centrifuge 100 to measure a density gradient formed in the samples held by the rotor 106 during and/or after centrifugation. Also, in some examples, the light interference can be used by the centrifuge 100 to monitor the particles of interest.

In some examples, the optical system 114 further includes a third sensor 114c that can be used by the centrifuge 100 to detect fluorescence by the particles of interest contained in the samples held by the rotor 106. In such examples, the third sensor 114c can include an off-axis orientation to detect a fluorescence signal from the particles of interest.

The processor 120 controls the components of the centrifuge 100 including the motor 110, the vacuum pump 112, the optical system 114, and the latch 118. The processor 120 also manages the information and graphics displayed on the instrument interface 126. The processor 120 is communicatively coupled to one or more computer readable storage media 124, such as a memory storage device. The computer readable storage media 124 encodes data instructions. When the data instructions are processed by the processor 120, the instructions cause the processor 120 to perform the functionalities described herein, and/or to interact with other components of the centrifuge 100 to perform the functionalities. Some examples include a non-transitory computer readable medium, or one or more non-transitory computer readable media.

The processor 120 can include one or more processing devices including a microprocessor, a microcontroller, a computer, or other suitable devices that control operation of devices and execute programs. Various other processor devices may also be used including central processing units (“CPUs”), microcontrollers, programmable logic devices, field programmable gate arrays, digital signal processing (“DSP”) devices, and the like. The processor 120 may include any general variety device such as a reduced instruction set computing (“RISC”) device, a complex instruction set computing (“CISC”) device, or a specially designed processing device such as an application-specific integrated circuit (“ASIC”) device.

The instrument interface 126 is an example of an input/output device that is configured for interaction with a user. The instrument interface 126 may be part of the centrifuge console, or it may be an external device connected to the centrifuge 100, such as a personal computer. In the disclosed example, the instrument interface 126 includes an instrument display 130 and one or more input interfaces 132. The instrument display 130 can be any display device, such as a computer monitor or a video screen. The input interface 132 can be any information entering device such as a keyboard, mouse, or a touch pad. In some embodiments, the instrument display 130 and the input interface 132 are combined in a touch-sensitive display.

Parameters of a centrifugation operation include rotor speed, rotor run time, and rotor chamber temperature, as well as detection parameters such as wavelength (for absorbance), scan frequency, and number of scans. The rotor speed is the rotational speed of the rotor 106 during the centrifugation operation. The rotor run time is the duration that the rotor 106 spins at the rotor speed. The rotor chamber temperature is the temperature inside the rotor chamber 104. A preset parameter is a value that the centrifuge 100 is prepared to apply. This may be a default value, a value from a previous centrifuge operation, a value that is entered or modified by a user through the input interface 132, or a programmed value. The processor 120 displays one or more preset parameters on the instrument display 130. During centrifugation, the processor 120 controls the motor 110 to spin the rotor 106 at a preset rotor speed for a preset run time, and can adjust the temperature inside the rotor chamber 104 to match a preset rotor chamber temperature.

As an illustrative example, the centrifuge 100 can rotate the rotor 106 at a rotor speed ranging from about 3,000 rpm to about 60,000 rpm (about 500×g to 290,000×g). As another illustrative example, the rotor chamber temperature can range from about 4 °C to about 40 °C.

In some examples, the centrifuge 100 enables multi-stage experiments where different combinations of parameters can be applied to a sample of lipid nanoparticles. In some examples, the centrifuge 100 is configured to perform multispeed experiments that ramp up the rotor speed from a minimum speed to a maximum speed in multiple steps and for a predetermined duration of time for each step. Also, the centrifuge 100 is configured to perform multispeed experiments that ramp down the rotor speed from the maximum speed to the minimum speed in multiple steps and for a predetermined duration of time for each step. Also, the detection parameters (e.g., wavelength for absorbance, scan frequency, and number of scans) can be varied for each stage of a multi-stage experiment run by the centrifuge 100.

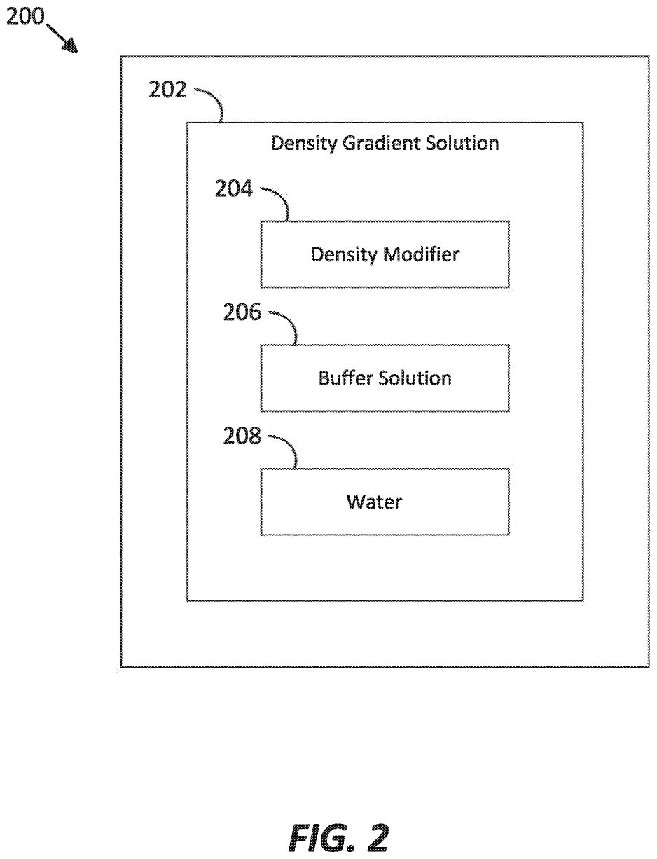

FIG. 2 illustrates an example of a kit 200 that can be used for analyzing a sample of lipid nanoparticles using the centrifuge 100. In one particular example, the kit 200 is used for analyzing a sample of lipid nanoparticles containing a payload. In some examples, the payload carried by the lipid nanoparticles includes one or more strands of mRNA.

The kit 200 includes a density gradient solution 202 having separate components. In this example, the density gradient solution 202 includes a density gradient forming material 204, a buffer solution 206, and can optionally include water 208. In alternative examples, the density gradient solution 202 can include additional components, or have fewer components. In some examples, the components of the density gradient solution 202 are in liquid form. In alternative examples, at least some of the components of the density gradient solution 202 are in dried form prior to mixing with the sample of particle of interested (e.g., lipid nanoparticles).

Increasing an amount of the density gradient forming material 204 relative to the other components of the density gradient solution 202 increases the density of the solution, while decreasing the amount of the density gradient forming material 204 relative to the other components of the density gradient solution 202 decreases the density of the solution. As an illustrative example, the density gradient forming material 204 can include one or more of the following: cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®. In some examples, combinations of different density gradient forming materials can be used for optimal resolution, density range, osmotic balance, and other desired characteristics. In some examples, the density gradient solution 202 includes a crowding material such as polyethylene glycol (PEG).

In some examples, the density gradient solution 202 is premixed and delivered to a customer. In other examples, the components of the density gradient solution 202 are delivered to the customer separately, and the customer mixes the components together to create the density gradient solution 202. In some examples, a predetermined amount of each of the components of the density gradient solution 202 are delivered to the customer, and thereafter, the customer mixes the components together to form the density gradient solution 202. The components of the density gradient solution 202 can be delivered in dried form or in liquid form.

In some examples, the customer generates and measures a density gradient formed from the density gradient solution 202 using the equipment and techniques described in U.S. Provisional Patent Application No. 63/369,299, entitled Non-Destructive Measurement of Density Gradients, filed Jul. 25, 2022, U.S. Provisional Patent Application No. 63/369,306, entitled Automatic Dispense of Density Gradients, filed Jul. 25, 2022, and U.S. Provisional Patent Application No. 63/369,318, entitled Replication of Density Gradients, filed Jul. 25, 2022, which are incorporated herein by reference in their entireties. Additional techniques for generating and measuring the density gradient solution 202 are contemplated.

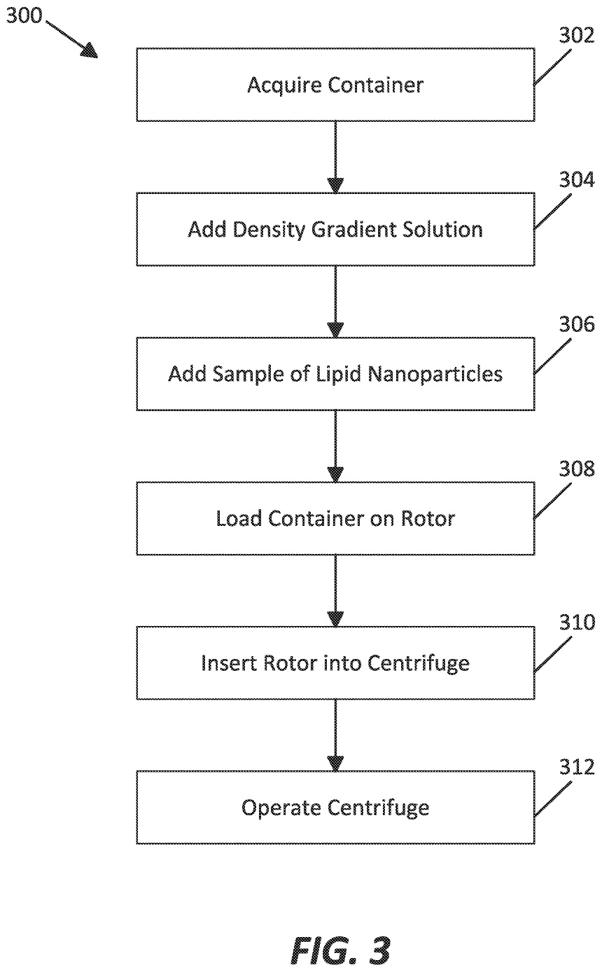

FIG. 3 schematically illustrates an example of a method 300 of operating the centrifuge 100 to analyze lipid nanoparticles. The method 300 includes an operation 302 of acquiring a container that can be loaded onto a rotor for centrifugation by the centrifuge 100.

Next, the method 300 includes an operation 304 of adding the density gradient solution 202 to the container acquired in operation 302. It is contemplated that the amount of the density gradient solution 202 added to the container may vary.

Next, the method 300 includes an operation 306 of adding a sample of lipid nanoparticles to the container. The order of operations 304, 306 can be reversed such that in some alternative examples, the sample of lipid nanoparticles is first added to the container, and the density gradient solution 202 is then added to the container afterwards.

Also, in some examples, the density gradient solution 202 can be combined with the sample of lipid nanoparticles in an outside vessel, and the solution is then transferred to the container that can be loaded onto the rotor for centrifugation by the centrifuge 100. In some examples, a density of about 1.0 to about 1.3 g/mL of the density gradient solution 202 is obtained after combining the density gradient solution 202 with the sample of lipid nanoparticles.

The method 300 includes an operation 308 of loading the container into the rotor 106. Operation 308 can include loading onto the rotor 106 multiple containers each containing a sample of lipid nanoparticles and the density gradient solution 202. In some examples, operation 308 includes loading onto the rotor 106 one or more containers including the density gradient solution 202 without the sample of lipid nanoparticles to function as a reference for the containers that include the sample of lipid nanoparticles and the density gradient solution. Additionally, one or more containers can be loaded onto the rotor 106 that are free of both the density gradient solution 202 and the lipid nanoparticles to function as an additional reference for monitoring the density gradient in the containers without the lipid nanoparticles.

Next, the method 300 includes an operation 310 of mounting the rotor 106 onto the centrifuge 100. As shown in FIG. 1, the rotor 106 can be inserted into the rotor chamber 104 by releasing the latch 118, and opening the door 116 to gain access to the rotor chamber 104 through the opening 122. Operation 310 can further include mounting the rotor 106 onto the drive shaft 108 allowing the motor 110 to rotate the rotor 106 about the axis of rotation R.

The method 300 includes an operation 312 of operating the centrifuge 100 to spin the rotor 106 about the axis of rotation R inside the rotor chamber 104. In some examples, the processor 120 controls the motor 110 to rotate in one or more stages that each include a preset rotor speed and a preset run time. The centrifugation by the centrifuge 100 causes formation of a density gradient in the container(s) that include the sample of lipid nanoparticles, and allows the optical system 114 to analyze and classify the lipid nanoparticles in the container(s) based on their position along the density gradient and/or radial position in the rotor chamber 104.

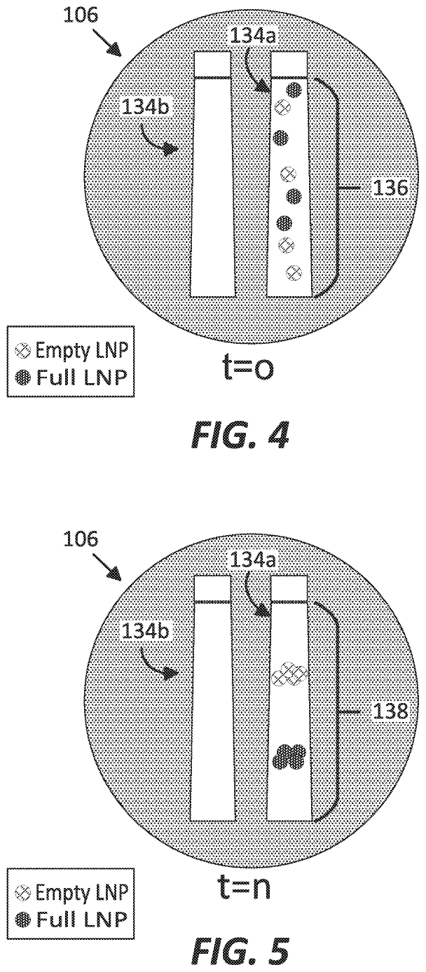

FIG. 4 illustrates an example of the rotor 106 holding a first container 134a having the density gradient solution 202 added to a sample of lipid nanoparticles 136 prior to centrifugation by centrifuge 100. In this example, the sample of lipid nanoparticles 136 includes lipid nanoparticles that are empty or partially full of payload, and lipid nanoparticles that have a full payload. The rotor 106 also holds a second container 134b that has the density gradient solution 202 without the sample of lipid nanoparticles 136. In this example, the second container 134b acts as a reference for the first container 134a.

FIG. 5 illustrates another example of the rotor 106 holding the first and second containers 134a, 134b after centrifugation by centrifuge 100 such that density gradients 138 are formed in the first and second containers 134a. During centrifugation, the lipid nanoparticles migrate to positions along the density gradient 138 where the density of the lipid nanoparticles matches the density of the surrounding media in the first container 134a, forming at least one detectable grouping. In FIGS. 4 and 5, the second container 134b is used to assess the density gradient 138 independently of the sample of lipid nanoparticles 136 in the first container 134a.

As shown in FIG. 5, the lipid nanoparticles that have a full payload are grouped with other similarly loaded lipid nanoparticles and are separated from the lipid nanoparticles that are empty or partially full of payload. For example, the lipid nanoparticles that have the full payload have a lower position (more radially outward) along the density gradient 138, while the lipid nanoparticles that are empty or that have a partially full payload have a higher position (more radially inward) along the density gradient 138. This is because the lipid nanoparticles that have the full payload have a higher density than the lipid nanoparticles that are empty or partially full. The lipid nanoparticles that have the full payload are denser because the cargo payload in these lipid nanoparticles (e.g., nucleic acids) is denser than the water/buffer solution that displaces the payload inside the interior space of the empty or partially full particles. The terms “full,” “partially full,” and “empty are used to indicate the quantity of a unit of payload encapsulated by a lipid based nanoparticle. For example, the terms can indicate the quantity of copies per particle, wherein the copies themselves could be units of nucleic acid, mRNA, small molecules, or another type of payload. Additionally, “full,” “partially full” or “empty” can be used to represent a range of quantities of copies per particle applying to the upper, middle, and lower portions of a broader range of quantities of copies per particle, respectively. In such a case the broader range of quantities fully encompasses the upper, middle, and lower portions.

Given the foregoing, the position of the lipid nanoparticles along the density gradient 138 corresponds to a fullness of the payload. A quantity of the lipid nanoparticles that have the full payload can be determined based on how much light is absorbed at a position along the density gradient 138. Similarly, a quantity of the lipid nanoparticles that have a partially full payload or that are empty can be determined based on how much light is absorbed at other positions along the density gradient 138.

The foregoing technique for analyzing lipid nanoparticles is different from sedimentation velocity-analytical ultracentrifugation (SV-AUC), which is a technique that can be used for discerning empty, partially full, and full AAV capsids by monitoring individual sedimentation rates (S value) within a sample. The technique of the present disclosure is different from SV-AUC because instead of measuring a pelleting or sedimentation rate for the lipid nanoparticles, the density of the particles is used for determining whether the particles are full, partially full, or empty. Advantageously, the density data used for classifying the lipid nanoparticles in accordance with the technique of the present disclosure is more easily interpretable, and does not require specialized analytical software. Also, the technique of the present disclosure can generate the density gradient 138 in less time than the period of time needed for reaching the equilibrium point in sedimentation equilibrium-AUC (SE-AUC), which is another technique that operates a centrifuge at low speeds for several days causing particles to reach an equilibrium point at which their sedimentation and diffusion rates are balanced. In SE-AUC, the particles themselves form a concentration gradient and there is no density gradient material added and there is no density gradient formed.

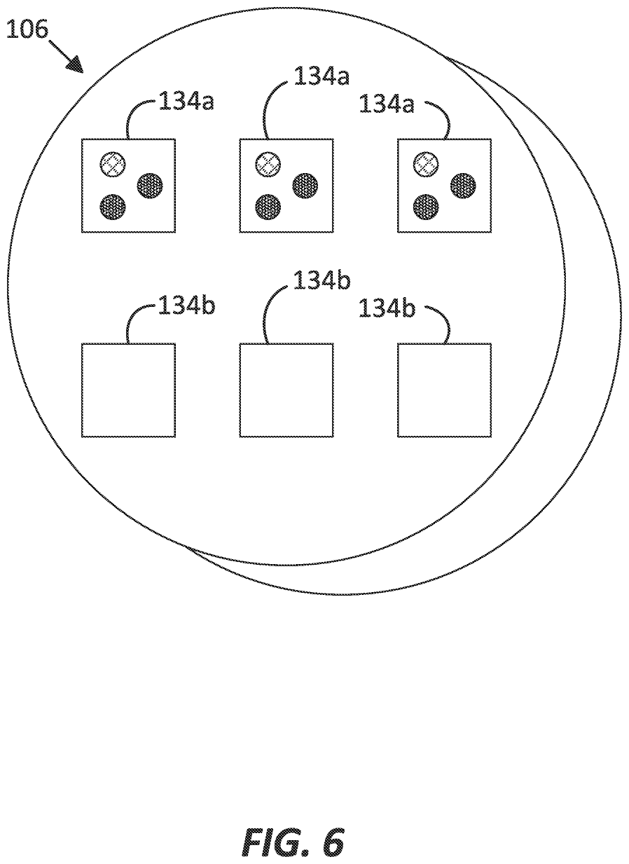

FIG. 6 illustrates another example of the rotor 106 for use with the centrifuge 100. In this example, the rotor 106 holds multiple containers (e.g., six containers) for centrifugation by the centrifuge 100. The rotor 106 holds multiple first containers 134a each having the density gradient solution 202 added to a sample of lipid nanoparticles 136, and multiple second containers 134b having the density gradient solution 202 by itself (i.e., without a sample of lipid nanoparticles). In this example, each of the second containers 134b acts as a reference for a first container 134a. In this example, the rotor 106 increases the throughput of the centrifuge 100 for analyzing samples of lipid nanoparticles. In further examples, alternative rotors may be used with the centrifuge 100 such as rotors configured to hold more than or less than six containers.

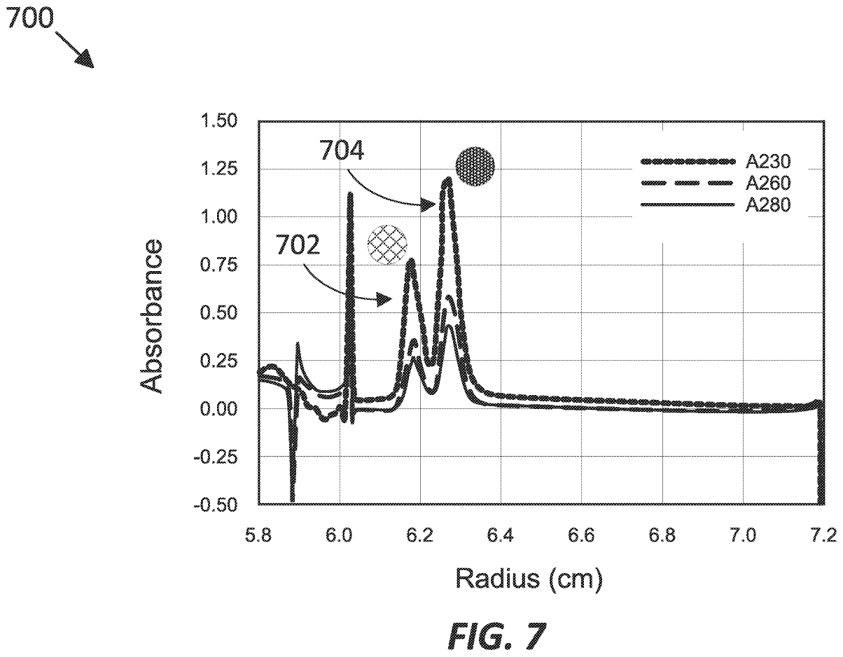

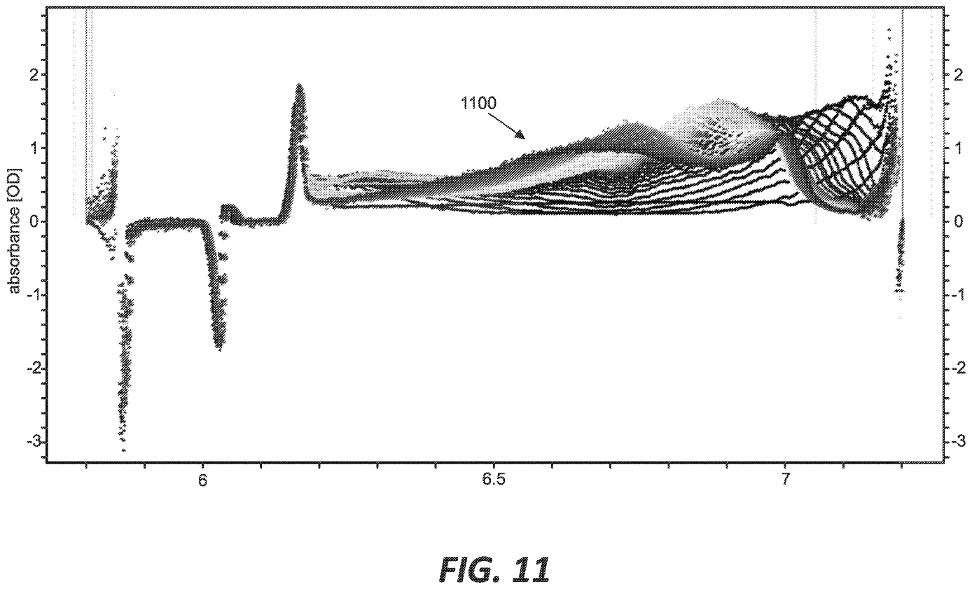

FIG. 7 illustrates a chart 700 of theoretical data including light absorbance measured along the density gradient 138 in the first container 134a after centrifugation by the centrifuge 100. In accordance with the example described above, the light absorbance is measured by the optical system 114 (i.e., the first sensor 114a) of the centrifuge 100. As shown in FIG. 7, a first peak of light absorption 702 is detected at a radial distance of about 6.2 cm. The first peak of light absorption 702 identifies lipid nanoparticles that are empty of a payload because these lipid nanoparticles have a lighter density. As further shown in FIG. 7, a second peak of light absorption 704 is detected at a radial distance of about 6.3 cm. The second peak of light absorption 704 identifies lipid nanoparticles that have a full payload because these lipid nanoparticles have a heavier density. An advantage of the foregoing technique is that raw data collected from the first container 134a allows simple viewing and analysis of the lipid nanoparticles by the centrifuge 100 without requiring complex computations. The theoretical data shown in FIG. 7 is supported by the empirical data illustrated in FIGS. 11-29, which will be described in greater detail below.

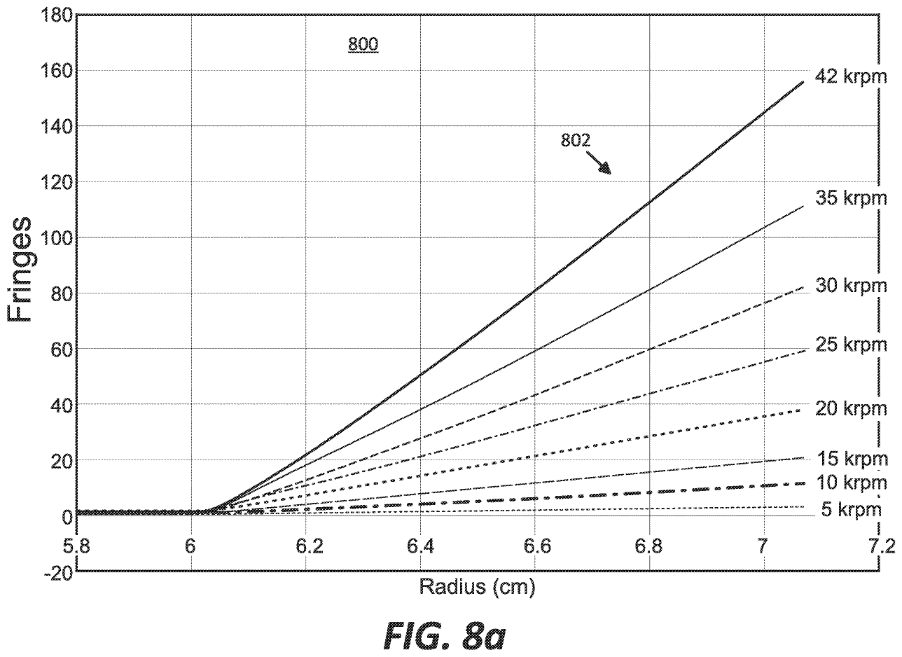

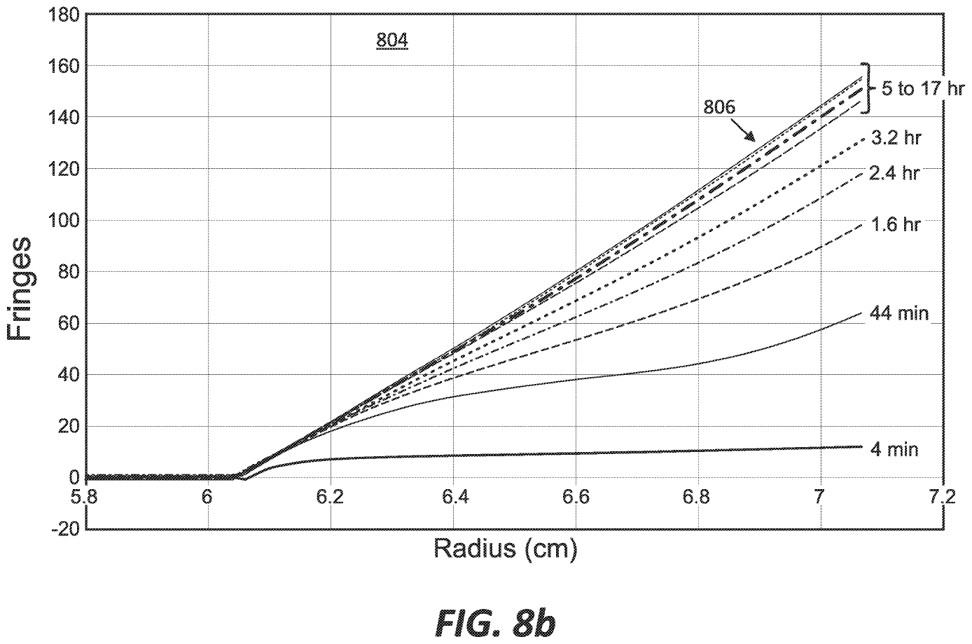

FIG. 8a illustrates an example of a chart 800 showing an effect of rotor speed on a density gradient 802 formed during centrifugation of the density gradient solution 202 by the centrifuge 100. The rotor speed is controlled by the processor 120 operating the motor 110 to drive the drive shaft 108 causing rotation of the rotor 106 about the axis of rotation R (see FIG. 1). The rotor speed of the centrifuge 100 can be adjusted during centrifugation. In this example, the rotor speed is maintained at 42,000 rpm for about 12 hours until equilibrium is reached, then dropped to 35,000 rpm for about 12 hours and so on all the way down to 5,000 rpm. As shown in FIG. 8a, higher rotor speeds cause the slope of the density gradient 802 (y-axis) to have a higher inclination along the radial distance of the container (x-axis), whereas lower rotor speeds cause the slope of the density gradients 802 to have a lower inclination.

FIG. 8b illustrates an example of a chart 804 showing an effect of time on a density gradient 806 formed during centrifugation of the density gradient solution 202 by the centrifuge 100. In certain examples, the second containers 134b that have the density gradient solution 202 by itself (i.e., without the sample of lipid nanoparticles 136) are monitored in accordance with the example shown in FIG. 8b to determine when equilibrium is reached.

The chart 804 is generated by maintaining the rotor speed at 42,000 rpm. As time progresses, the density gradient 806 becomes steeper which indicates that the density gradient is being formed. In this illustrative example, changes in the density gradient 806 stop at about 6-8 hours indicating that the density gradient is fully equilibrated at this time. Thus, in this example, the density gradient solution 202 reaches equilibrium within about 6-8 hours at 42,000 rpm.

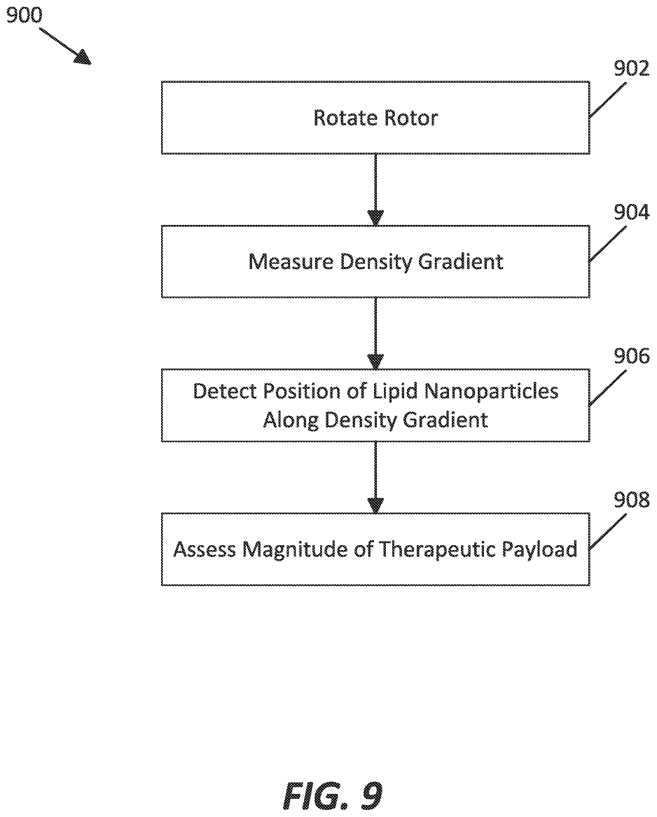

FIG. 9 schematically illustrates an example of a method 900 of classifying lipid nanoparticles that can be performed by the centrifuge 100. The method 900 includes an operation 902 of rotating the rotor 106 about the axis of rotation R at a preset rotor speed for a preset run time. During operation 902, the rotor 106 holds at least one container having the density gradient solution 202 added to a sample of lipid nanoparticles that can be prepared in accordance with the operations of the method 300 described above with respect to FIG. 3. As discussed above, the lipid nanoparticles in the sample are designed to carry a payload.

In some examples, the rotor 106 is rotated at the preset rotor speed ranging from about 3,000 rpm to about 60,000 rpm. The preset rotor speed is higher than in SE-AUC. In some example, the preset run time ranges from about 1 hour to about 72 hours. The preset run time is less than the time needed to measure equilibration rate in SE-AUC.

The rotation of the at least one container during operation 902 forms a continuous density gradient. Operation 902 can include increasing the preset rotor speed to increase a slope of the continuous density gradient for detecting a broader range of densities. Alternatively, operation 902 can include decreasing the preset rotor speed to decrease a slope of the continuous density gradient for detecting a higher resolution of densities. In some examples, operation 902 can include both increasing the preset rotor speed and decreasing the preset rotor speed to adjust the slope of the continuous density gradient during centrifugation. In some examples, the centrifuge 100 is programmed to adjust the slope of the density gradient based on the light absorption and/or the light inference measured by the optical system 114 during centrifugation.

The method 900 further includes an operation 904 of measuring a density gradient. The density gradient can be measured using the optical system 114 of the centrifuge 100. For example, the second sensor 114b detects light interference in the one or more second containers 134b (see FIGS. 4-6) for measuring the density gradient in operation 904.

In some examples, operation 904 is performed during centrifugation such that the density gradient is measured while the rotor is being rotated. In such examples, operation 904 occurs simultaneously with operation 902 to determine when to stop the centrifugation such as when the density gradient has reached equilibrium. In other examples, operation 904 is performed after completion of operation 902 such as when the preset run time expires.

Next, the method 900 includes an operation 906 of detecting and/or measuring positions of the lipid nanoparticles relative to the density gradient measured in operation 904. Operation 906 can include measuring light absorption data in the one or more first containers 134a (see FIGS. 4-6). The light absorption data can be measured using the optical system 114 of the centrifuge 100. For example, the first sensor 114a detects the light absorption data in the one or more first containers 134a. In some instances, the light absorption data measured in operation 906 can resemble the data shown in the chart 700 of FIG. 7.

The method 900 further includes an operation 908 of assessing a magnitude of the payload in the lipid nanoparticles. In some examples, operation 908 includes classifying the lipid nanoparticles based on the positions of the lipid nanoparticles relative to the density gradient. As an illustrative example, operation 908 can include determining a quantity of the lipid nanoparticles that have a full payload based on their position along the density gradient, and determining a quantity of the lipid nanoparticles that do not have a full payload based on their position along the density gradient.

As an illustrative example, an absolute quantity of either full or empty or partially full lipid nanoparticles can be determined from detected light absorbance at a predetermined range of radial positions such as one known to correspond to the full or empty or partially full species of lipid nanoparticles. In FIG. 7, an absolute quantity of empty lipid nanoparticles is obtained from a total area under the curve at a radial position of about 6.2 cm. An absolute quantity of full lipid nanoparticles is obtained from a total area under the curve at a radial position of about 6.3 cm. A ratio of these two areas gives a proportion of empty lipid nanoparticles to full lipid nanoparticles. Thus, a radial position of a peak in light absorbance can be used to classify the lipid nanoparticles, and an area under the curve at the peak in light absorbance can be used to determine a quantity of the lipid nanoparticles for the given class of lipid nanoparticles.

In some examples, operation 908 includes classifying the lipid nanoparticles between a first group having a full payload and a second group that does not have a full payload. Additional examples of classifying the lipid nanoparticles are possible.

In some further examples, operation 908 includes calculating a ratio of the quantity of the lipid nanoparticles having the full payload versus the quantity of the lipid nanoparticles that do not have the full payload. Additional examples of the ratios that can be calculated for classifying the lipid nanoparticles are possible.

The method 900 has several advantages over SV-AUC and SE-AUC. For example, by forming a density gradient that is used to distinguish the lipid nanoparticles that include a full payload from those that do not, the method 900 is less sensitive to sample misalignment and temperature fluctuations. Also, raw data (e.g., light absorption) collected from the method 900 is readily understandable and can be managed using simple data visualization tools instead of relying on extensive mathematical deconvolution provided by elaborate and specialized software packages, which is typical in SV-AUC and SE-AUC. Also, the method 900 is not limited by particle size (as is the case for SV-AUC), thus allowing a universal approach to characterizing lipid nanoparticles having a variety of sizes and payloads.

Also, the method 900 (unlike SV-AUC) is not time-resolved, but is rather an endpoint analysis, which allows more wavelengths to be assessed without sacrificing more time points for wavelengths. This is especially advantageous for larger, fast-sedimentation particles like lipid nanoparticles (which is another benefit over AAVs, as lipid nanoparticles have higher S values and thus give less time to analyze via SV-AUC before they sediment). Another advantage over both SV-AUC and SE-AUC is that the sample by nature of the method 900 gets concentrated within the density gradient, thereby allowing lesser sample quantities to be analyzed.

The method 900 can generate a density gradient in a shorter period of time than reaching equilibrium in SE-AUC. For example, the method 900 can generate a density gradient in about 1 to about 72 hours, while SE-AUC typically requires about 3 days to about 7 days to reach equilibrium. Also, the method 900 can separate full lipid nanoparticles from partially full lipid nanoparticles with a reduction in sample quantity requirements compared to SV-AUC.

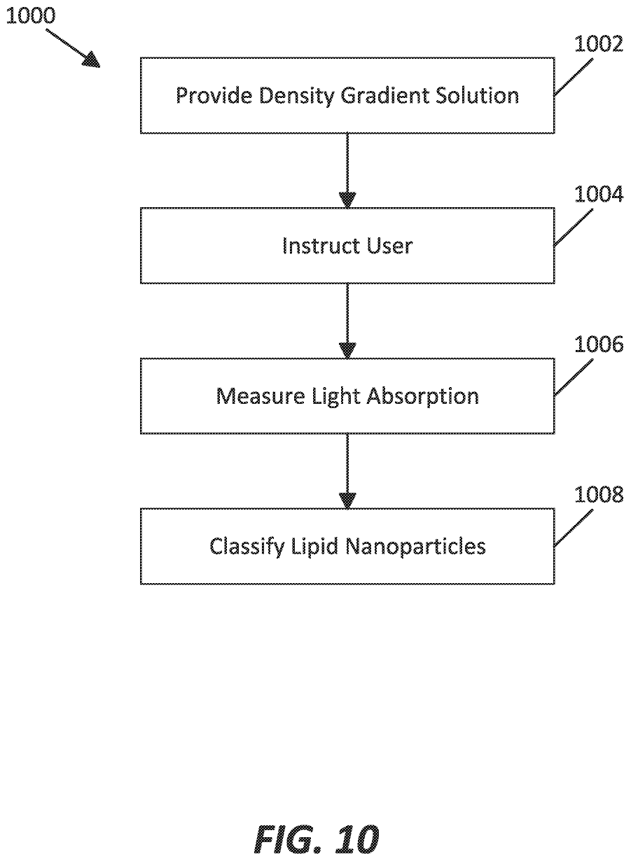

FIG. 10 schematically illustrates an example of a method 1000 of classifying lipid nanoparticles that can be performed using the centrifuge 100. The method 1000 includes an operation 1002 of providing the density gradient solution 202. As described above, the density gradient solution 202 provided in operation 1002 can include a density gradient forming material 204, a buffer solution 206, and water 208. The density gradient forming material 204 can include one or more of the following: cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.

In some examples, the density gradient solution 202 is premixed and delivered to a customer. In other examples, the components of the density gradient solution 202 are delivered to the customer separately, and the customer mixes the components together to create the density gradient solution 202. In some examples, a predetermined amount of each of the components of the density gradient solution 202 are delivered to the customer, and thereafter, the customer mixes the components together to form the density gradient solution 202. In some examples, at least some of the components of the density gradient solution 202 are in dried form.

The method 1000 includes an operation 1004 of operating the centrifuge 100 for analyzing the lipid nanoparticles. In some examples, operation 1004 includes at least some of the operations described above with respect to the method 300. For example, operation 1004 can include acquiring a container; adding to the container a sample of lipid nanoparticles carrying payloads and the density gradient solution 202; loading the container onto the rotor 106; inserting the rotor 106 into the centrifuge 100; and using the centrifuge 100 to perform centrifugation of the container that includes the sample of lipid nanoparticles carrying payloads and the density gradient solution 202. The centrifuge 100 is programmed to perform the centrifugation by rotating the rotor 106 about the axis of rotation R at one or more stages each defined by a preset rotor speed and preset run time to generate a density gradient for separating the lipid nanoparticles based on the fullness of their payloads.

Next, the method 1000 includes an operation 1006 of measuring light absorption from the lipid nanoparticles suspended in the density gradient that is generated in the container after centrifugation is complete. Operation 1006 can include generating a chart that includes a light absorption (y-axis) over a length of the container (x-axis).

The method 1000 further includes an operation 1008 of classifying the lipid nanoparticles based on the measured light absorption. The lipid nanoparticles that have a full payload will be denser than the lipid nanoparticles that do not have a full payload such that different peaks will occur in the light absorption measured from the container after centrifugation is complete. A difference between the peaks in the light absorption can be used to calculate a ratio of a quantity of lipid nanoparticles having the full payload versus a quantity of the lipid nanoparticles that do not have a full payload.

FIG. 11 illustrates empirical data 1100 of light absorption (y-axis) measured across a length of a container (x-axis) during centrifugation by the centrifuge 100. The empirical data 1100 is measured from an experiment that used a sample of lipid nanoparticles having a total volume of 75 μL of which 50 μL includes lipid nanoparticles having an empty payload and 25 μL includes lipid nanoparticles having a full payload. The sample of lipid nanoparticles is mixed with a density gradient solution 202 having 3% sucrose as the density gradient forming material. The experiment was run by rotating the rotor 106 at a constant speed of 60 krpm and at a constant temperature of 20 °C for a runtime of 43 hours. The light absorption is measured at a wavelength of 230 nm. The empirical data 1100 is based on a total of 259 scans measured every 10 minutes over the 43 hour duration of the experiment, with every 5^{th} scan (i.e., one plot every 50 minutes) being shown in the empirical data 1100 of FIG. 11.

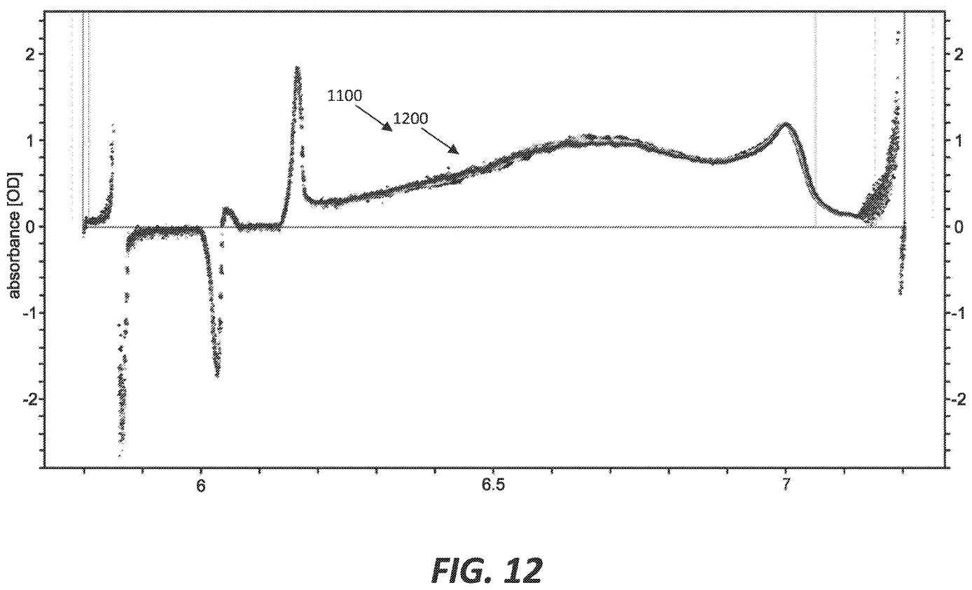

FIG. 12 illustrates a portion 1200 of the empirical data 1100 of FIG. 11. The portion 1200 includes scans that are measured toward an end of the experiment after equilibrium has been attained inside the container. For example, the portion 1200 includes the last 20 scans (scans 239-259) measured during hours 40-43 of the experiment. This corresponds to 200 minutes of plot data (10 minutes between scans) when the sample of lipid nanoparticles and the density gradient solution 202 have attained equilibrium inside the container.

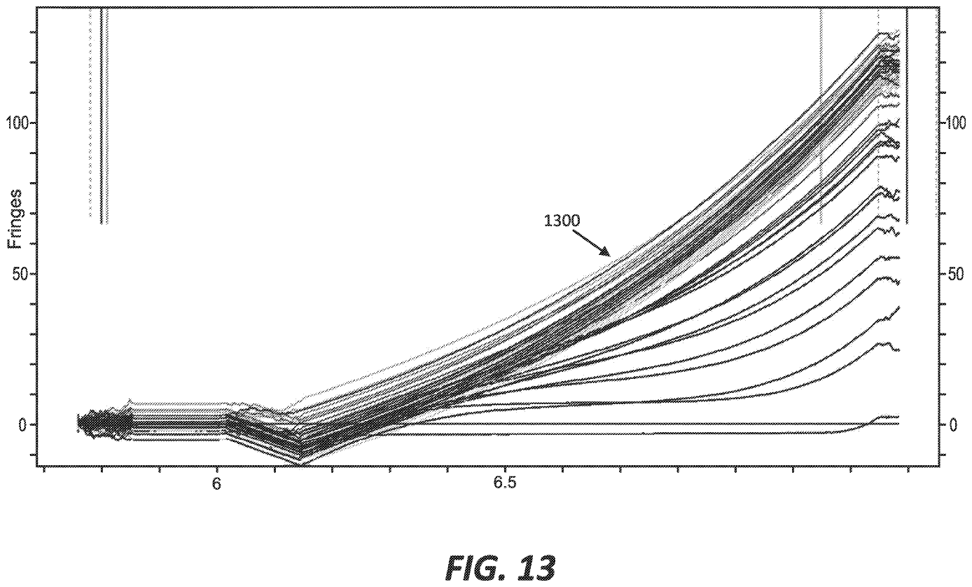

FIG. 13 illustrates empirical data 1300 of Rayleigh interference fringes (RIF) (y-axis) measured across the length of the container (x-axis) during centrifugation by the centrifuge 100. The empirical data 1300 is measured from the experiment of FIGS. 11 and 12, which as described above, uses a sample of lipid nanoparticles having a total volume of 75 μL (with 50 μL of lipid nanoparticles having an empty payload and 25 μL of lipid nanoparticles having a full payload) that is mixed with the density gradient solution 202 having 3% sucrose as the density gradient forming material 204. The experiment was run by rotating the rotor 106 at a constant speed of 60 krpm and at a constant temperature of 20 °C for a runtime of 43 hours.

The empirical data 1300 shown in FIG. 13 is based on a total of 518 scans measured every 5 minutes over the 43 hour duration of the experiment, with every 10th scan (i.e., one plot every 50 minutes) being shown. The RIF (y-axis) monitors the density gradient forming material 204 (sucrose) during the experiment. The density gradient forming material 204 is approaching equilibrium in the empirical data 1300, as shown by an increasing slope of the scans.

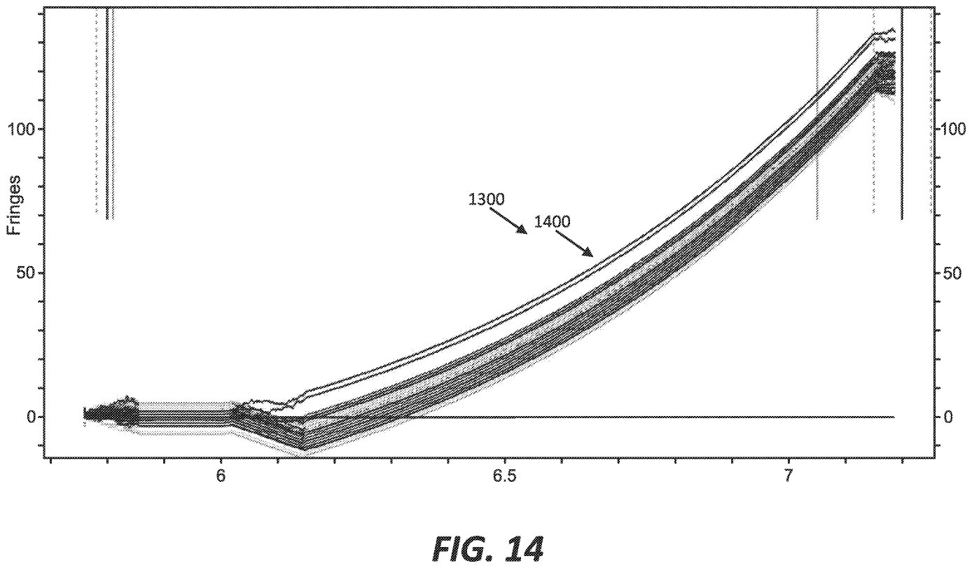

FIG. 14 illustrates a portion 1400 of the empirical data 1300 of FIG. 13. The portion 1400 includes scans that are measured toward the end of the experiment after equilibrium has been attained inside the container. For example, the portion 1400 includes scans 478-518 measured during hours 40-43 of the experiment. This corresponds to 40 plots measured every 5 minutes. The portion 1400 shows that the density gradient forming material 204 has attained equilibrium because the curvature of the scans does not change.

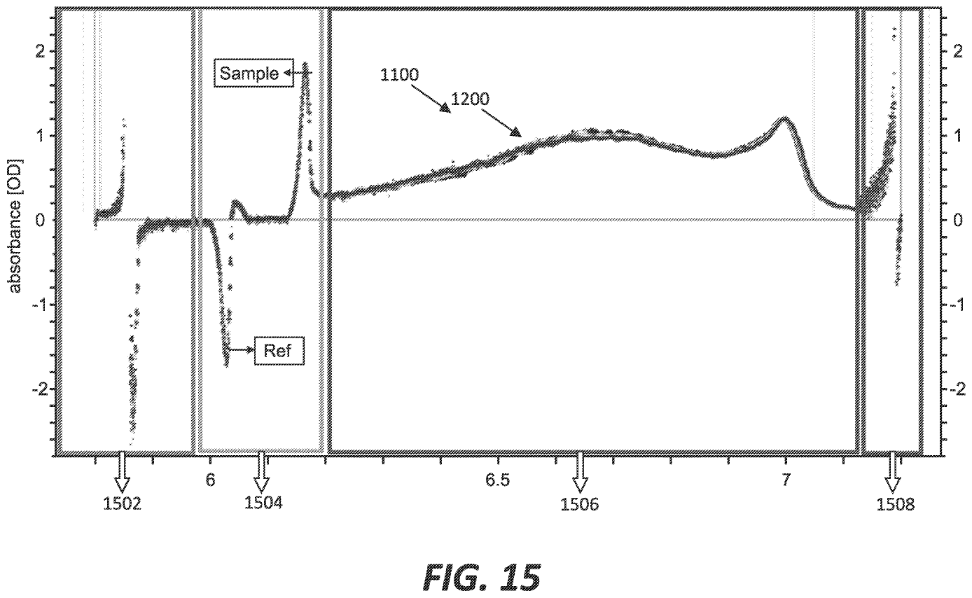

FIG. 15 illustrates segmentation of the portion 1200 of the empirical data 1100 from FIG. 12. As described above, the empirical data 1100 includes light absorption (y-axis) measured across a length of a container (x-axis) during centrifugation by the centrifuge 100. Different regions of the container are shown along the x-axis in FIG. 15. A first region 502 of the x-axis includes data measured from an air gap above the sample of lipid nanoparticles in the container (the container is not filled to the brim with the sample of lipid nanoparticles such that there is a small air gap region). The light absorption data in the first region 502 is ignored during an analysis of the empirical data 1100. A second region 504 is the meniscus formed in the container between the air gap and the sample of lipid nanoparticles. The light absorption data in the second region 504 is similarly ignored during the analysis. A third region 506 is density gradient region. The light absorption data in the third region 506 is analyzed for assessing a magnitude of payload carried in the sample of lipid nanoparticles based on the light absorption, as will be described in more detail further below. A fourth region 508 is the bottom of the container. The light absorption data in the fourth region 508 is ignored during the analysis.

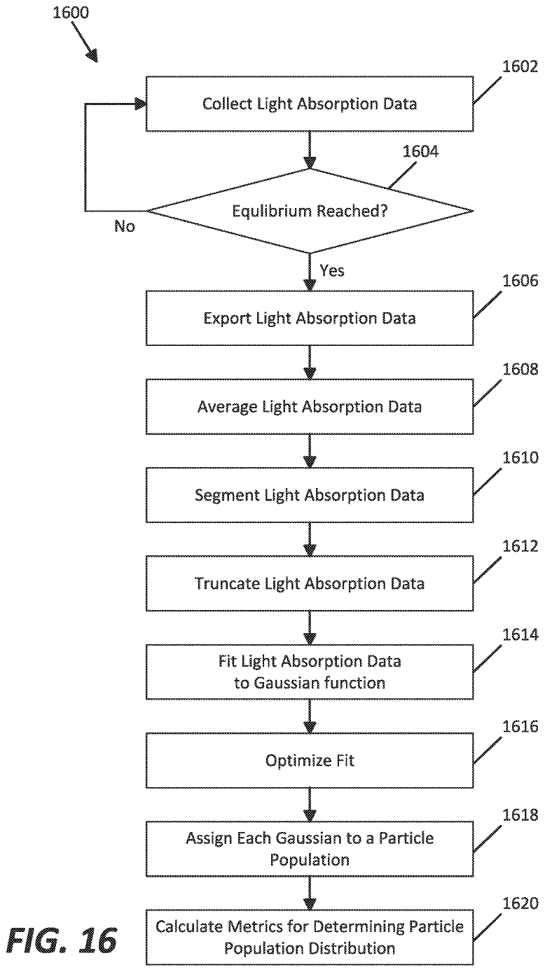

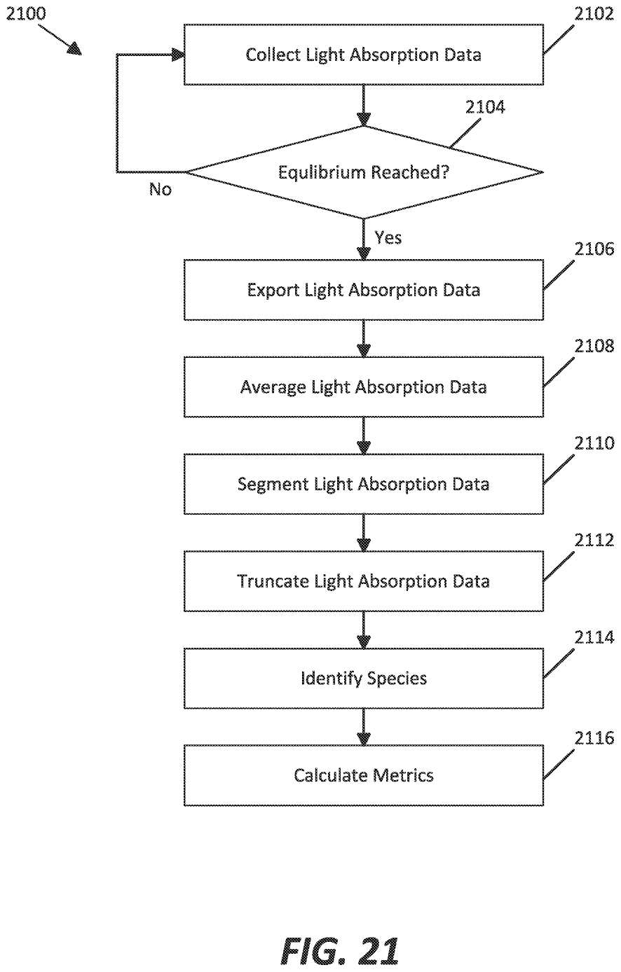

FIG. 16 schematically illustrates an example of a method 1600 of assessing a magnitude of payload carried in a sample of lipid nanoparticles based on the light absorption. The method 1600 is an example of using density gradient equilibrium analytical ultracentrifugation to determine relative populations of different lipid nanoparticle (LNP) species such as (i) empty or control LNPs, (ii) partially loaded LNPs, (iii) fully loaded LNPs, (iv) disrupted LNPs, and (v) free floating drug cargo. While the method 1600 is described with regards to classifying LNPs it is noted that at least some of the operations of the method 1600 can also be performed to classify liposomes, as will be described below with regards to FIG. 21.

As shown in FIG. 16, the method 1600 includes an operation 1602 of collecting light absorption data during centrifugation by the centrifuge 100. The light absorption data is collected from a container having a sample of lipid nanoparticles mixed with a density gradient solution 202. As an illustrative example, the density gradient solution 202 can include 3% concentration of sucrose as the density gradient forming material 204. Operation 1602 can include rotating the rotor 106 at a constant speed and at a constant temperature. For example, operation 1602 can include rotating the rotor 106 at a constant speed of about 60 krpm and at a constant temperature of about 20 °C. Operation 1602 can include measuring the light absorption data at a predetermined wavelength such as 230 nm. Operation 1602 can include measuring the light absorption data at predetermined intervals such as every 10 minutes.

The method 1600 includes an operation 1604 of determining whether equilibrium has been reached by the sample of lipid nanoparticles mixed with the density gradient solution 202. Operation 1604 can include inspecting the RIF data (see FIGS. 13 and 14) to determine whether the equilibrium is reached such as by determining whether a constant curvature of the scans is reached. Additionally, operation 1604 can include inspecting the light absorption data (see FIGS. 11 and 12) to determine whether the equilibrium is reached. When operation 1604 determines that equilibrium is not reached (i.e., “No” in operation 1604), the method 1600 returns to operation 1602 to continue collecting the light absorption data during centrifugation.

When operation 1604 determines that equilibrium is reached (i.e., “Yes” in operation 1604), the method 1600 proceeds to an operation 1606 of exporting the light absorption data. In some examples, operation 1606 includes exporting a portion of the light absorption data such as the last 10 to 20 scans of a 200 scan experiment (see the portion 1200 shown in FIG. 12). Operation 1606 can further include performing one or more data quality checks such as checking for missing scans in the portion of the light absorption data that is exported. In some instances, operation 1606 includes an extract, transform, load (ETL) workflow.

The method 1600 includes an operation 1608 of averaging the scans included in the light absorption data exported in operation 1606. By averaging the scans, operation 1608 can provide a better signal to noise ratio for the light absorption data.

The method 1600 includes an operation 1610 of segmenting the light absorption data. For example, operation 1610 can include segmenting the light absorption data into the regions shown in FIG. 15 such as the first region 1502, the second region 1504, the third region 1506, and the fourth region 1508. Thereafter, the method 1600 includes an operation 1612 of truncating the light absorption data. Operation 1612 can include removing the first, second, and fourth regions 1502, 1504, 1508 from the third region 1506 which includes the density gradient formed by centrifugation. Operation 1612 can include truncating the light absorption data such that the third region 1506 includes an axial length of the container of 6.2 cm to 7.1 cm (see FIG. 15).

The method 1600 includes an operation 1614 of fitting the light absorption data to a Gaussian function such as Equation 1,

$$f ( x ) = {A}_{n} {e}^{- {( \frac{x - {C}_{n}}{\sqrt{2} {s}_{n}} )}^{2}} \qquad ( 1 )$$

where n is a number of Gaussian fittings, Cₙ is a center position for the n-th Gaussian fitting, Aₙ is an amplitude for the n-th Gaussian fitting, and Sn is a width for the n-th Gaussian fitting.

The method 1600 can include an operation 1616 of optimizing the Gaussian fitting of the light absorption data by include increasing n until a fit quality is optimized. In this example, the fit quality is optimal when a value of residual function is minimized.

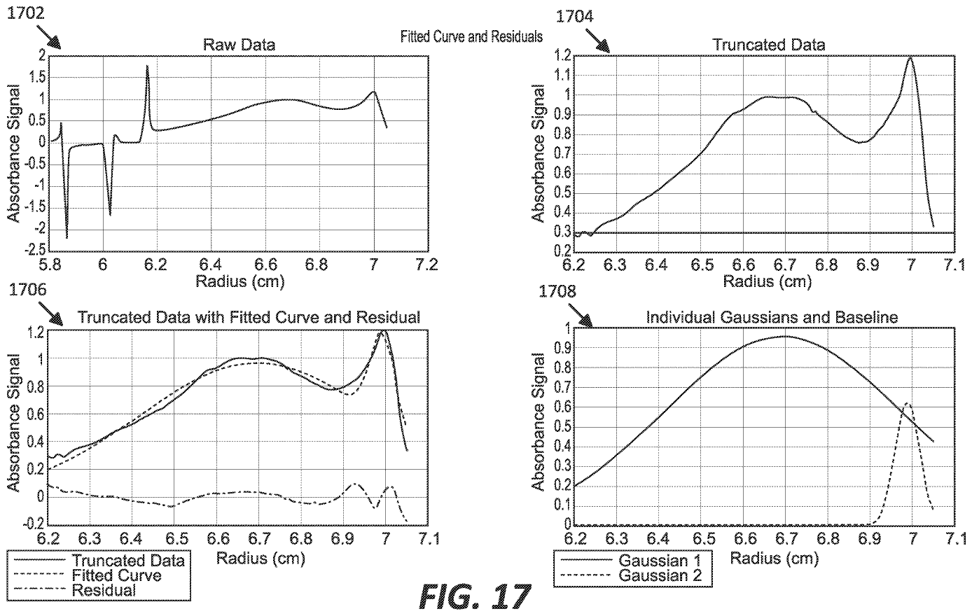

FIGS. 17-20 each illustrate examples of performance of the operations 1608-1616 of the method 1600 on the empirical data 1100. For example, FIGS. 17-20 each include a chart 1702, 1802, 1902, 2002 of the light absorption data after averaging is completed in operation 1608. FIGS. 17-20 each include a chart 1704, 1804, 1904, 2004 of the light absorption data after truncating is completed in operation 1612. FIGS. 17-20 each include a chart 1706, 1806, 1906, 2006 showing a fitted curve and a residual curve after fitting the light absorption data to the Gaussian function is completed in operation 1614. FIGS. 17-20 each include a chart 1708, 1808, 1908, 2008 showing discrete Gaussian curves extracted from the fitted curves.

In FIG. 17, n is set to two such that the light absorption data is fitted to two Gaussian curves in chart 1708. In this example, the residual curve in chart 1706 has an average value of 1.346698. In this example, operation 1616 can include increasing n to three to further minimize the value of the residual function to optimize the fit quality of the light absorption data.

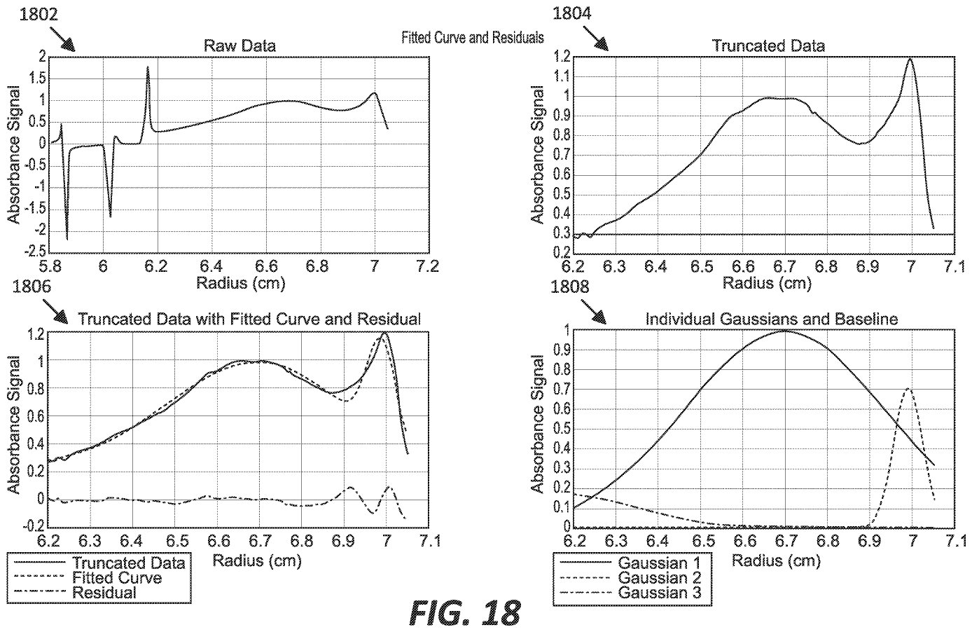

In FIG. 18, n is increased to three such that the light absorption data is fitted to three Gaussian curves in chart 1808. In this example, the residual curve in chart 1806 has an average value of 1.104727. This is lower than the average value of the residual curve shown in chart 1706 of FIG. 17. Thus, operation 1616 can further include increasing n to four to further minimize the value of the residual function to optimize the fit quality of the light absorption data.

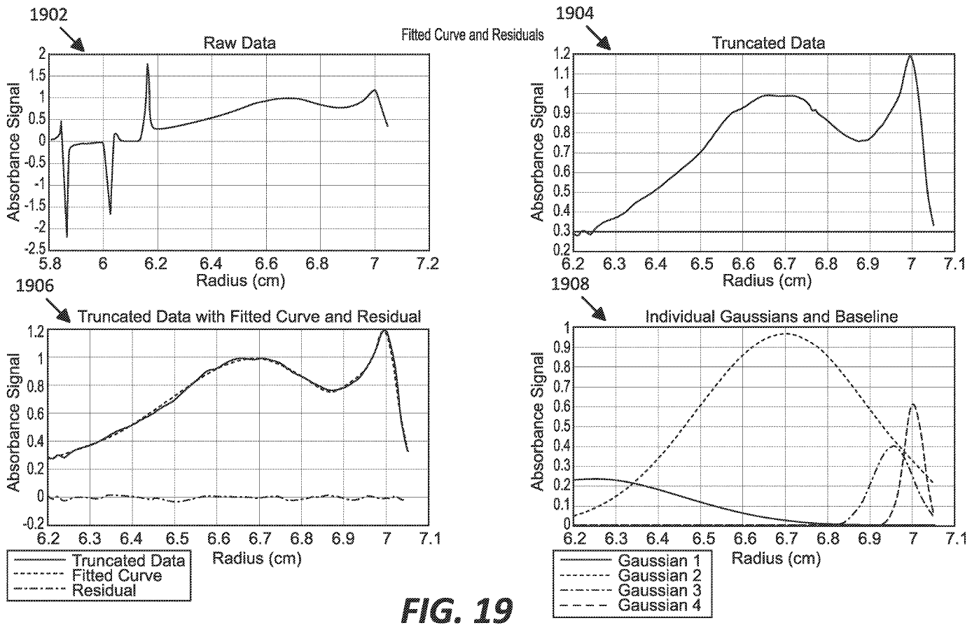

In FIG. 19, n is increased to four such that the light absorption data is fitted to four Gaussian curves in chart 1908. In this example, the residual curve in chart 1906 has an average value of 0.300438. This is lower than the average value of the residual curve shown in chart 1806 of FIG. 18. Thus, operation 1616 can further include increasing n to five to further minimize the value of the residual function to optimize the fit quality of the light absorption data.

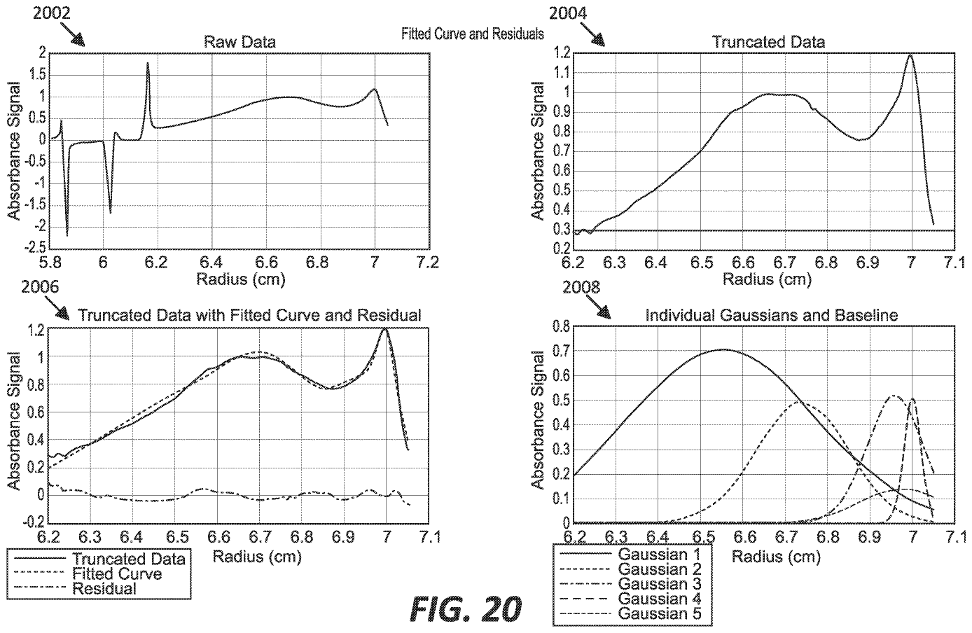

In FIG. 20, n is increased to five such that the light absorption data is fitted to five Gaussian curves in chart 2008. In this example, the residual curve in chart 2006 has an average value of 0.843571. This is greater than the average value of the residual curve shown in the chart 1906 of FIG. 19. Thus, operation 1616 includes determining that the fit quality is optimized when the light absorption data is fitted to four Gaussian curves. This suggests that there are four separate particle populations in the sample of lipid nanoparticles.

Referring back to FIG. 16, the method 1600 further includes an operation 1618 of assigning each Gaussian curve to a particle population in the sample of lipid nanoparticles. Operation 1618 can include assigning an empty lipid nanoparticle population to a first Gaussian curve, assigning a partially loaded lipid nanoparticle population to a second Gaussian curve, assigning a fully loaded lipid nanoparticle population to a third Gaussian curve, assigning a disrupted lipid nanoparticle shell population to a fourth Gaussian curve, assigning an mRNA cargo population to a fifth Gaussian curve, and so on.

Referring now to the chart 1908 in FIG. 19, Gaussian curves having peaks at the right side of the x-axis are associated with particle populations having a heavier load than the particle populations associated with Gaussian curves having peaks at the left side of the x-axis. This is because the right side of the x-axis is located towards the bottom of the container where the density values in the density gradient are highest and the left side of the x-axis is located towards the top of the container where the density values in the density gradient are lowest. Thus, Gaussian curve 3 is associated with particle populations having a highest density while Gaussian curve 1 is associated with particle populations having a lowest density.

Referring back to FIG. 16, the method 1600 further includes an operation 1620 of calculating one or more metrics of the Gaussian curves assigned in operation 1618 to the particle populations. Operation 1620 can include calculating an amplitude, a center, and an area for each Gaussian curve associated with a particle population.

Table 1 provides metrics calculated in operation 1620 for the Gaussian curves shown in the chart 1908 of FIG. 19. As discussed above, the fit quality is optimized when the light absorption data is fitted to the four Gaussian curves of FIG. 19. Referring now to FIG. 19 and Table 1, Gaussian curve 1 has a peak amplitude at a center location of 6.252278 cm, which is farthest on the left side of the x-axis. Gaussian curve 1 is assigned to a first particle population associated with a lowest density such as disrupted lipid nanoparticle shells. Gaussian curve 1 has an area of 0.074633 which accounts for about 11.95% of the total area of 0.624805. Thus, 11.95% of the sample of lipid nanoparticles includes the first particle population.

TABLE 1

| Gaussian | Amplitude | Center | STDEV | Area | Particle Population | % Population |
|---|---|---|---|---|---|---|
| 1 | 0.232663 | 6.252278 | 0.304485 | 0.074633 | Disrupted LNP Shells | 11.95 |
| 2 | 0.967022 | 6.698702 | 0.289326 | 0.471041 | Empty LNPs | 75.39 |
| 3 | 0.609082 | 7.002682 | 0.032461 | 0.034405 | Fully Loaded LNPs | 5.51 |
| 4 | 0.399739 | 6.956564 | 0.06437 | 0.044726 | Partially Loaded LNP | 7.16 |
| Total | | | | 0.624805 | | |

Gaussian curve 2 has a peak amplitude at a center location of 6.698702 cm, which is on the right of Gaussian curve 1. Gaussian curve 2 is assigned to a second particle population associated with a higher density such as empty lipid nanoparticles. Gaussian curve 2 has an area of 0.471041 which accounts for about 75.39% of the total area 0.624805 of the Gaussian curves. Thus, 75.39% of the sample of lipid nanoparticles includes the second particle population.

Gaussian curve 3 has a peak amplitude at a center location of 7.002682 cm, which is farthest on the right side of the x-axis. Gaussian curve 3 is assigned to a third particle population associated with a highest density such as fully loaded lipid nanoparticles. Gaussian curve 3 has an area of 0.034405 which accounts for about 5.51% of the total area 0.624805. Thus, 5.51% of the sample of lipid nanoparticles includes the third particle population.

Gaussian curve 4 has a peak amplitude at a center location of 6.956564 cm, which is on the left of Gaussian curve 3. Gaussian curve 4 is assigned to a fourth particle population associated with a lower density such as partially loaded lipid nanoparticles. Gaussian curve 4 has an area of 0.044726 which accounts for about 7.16% of the total area (0.624805) of the Gaussian curves. Thus, 7.16% of the sample of lipid nanoparticles includes the fourth particle population.

FIG. 21 schematically illustrates an example of a method 2100 of assessing a magnitude of payload carried in a sample of liposomes based on light absorption. The method 2100 is an example of using density gradient equilibrium analytical ultracentrifugation to determine relative populations of different liposome species such as (i) empty or control liposomes, (ii) partially loaded liposomes, (iii) fully loaded liposomes, (iv) disrupted liposomes, and (v) free floating drug cargo.

As shown in FIG. 21, the method 2100 can include an operation 2102 of collecting light absorption data during centrifugation by the centrifuge 100; an operation 2104 of determining whether equilibrium has been reached by the sample of liposomes mixed with the density gradient solution 202; an operation 2106 of exporting the light absorption data; an operation 2108 of averaging the scans included in the light absorption data exported in operation 2106; and operation 2110 of segmenting the light absorption data; and an operation 2112 of truncating the light absorption data. Operations 2102-2112 of the method 2100 are the same as operations 1602-1612 of the method 1600 such that the description of operations 1602-1612 provided above similarly applies to the operations 2102-2112 of the method 2100.

As shown in FIG. 21, the method 2100 includes an operation 2114 of identifying the liposome species from the light absorption data truncated in operation 2112. In contrast to the method 1600 of assessing lipid nanoparticles, the method 2100 can identify the liposome species without fitting and deconvoluting the light absorption data using the Gaussian function (see Equation 1). Thus, operation 2114 can include simply identifying species that are visible in the truncated light absorption data without further processing. In some instances, operation 2114 can include drawing demarcating boxes corresponding to a region for each liposome species.

The method 2100 includes an operation 2116 of calculating one or more metrics of the liposome species identified in operation 2114. Operation 2116 can include calculating an amplitude, a center, and an area-under-curve for each liposome species. Operation 2116 is similar to operation 1620 of the method 1600. Operation 2116 can include calculating the area-under-curve for each demarcating box corresponding to a liposome species such that the percentage of the area-under-curve for a demarcating box with respect to a total area-under-curve corresponds the percentage of the liposome species in the sample of liposomes.

In some instances, operations 2108-2116 can be performed for different wavelengths of the light absorption data captured from the sample of liposomes. For example, light absorption data at a wavelength of 230 nm shows both empty and full liposome species as well as any partially loaded liposomes. Payloads or cargos loaded into the liposomes generate absorbance signals at a different wavelength. For example, payloads such as doxorubicin absorb light at 490 nm. The light absorption data at a wavelength of 490 nm monitors the drug doxorubicin directly, regardless of whether it is inside a liposome or free floating in solution. The 490 nm absorbance monitors the dug payload directly. Therefore, by combining the 230 nm absorbance data and the 490 nm absorbance data, species which have a peak at 230 nm as well as a peak at 490 nm can be identified as fully loaded liposomes or partially loaded liposomes.

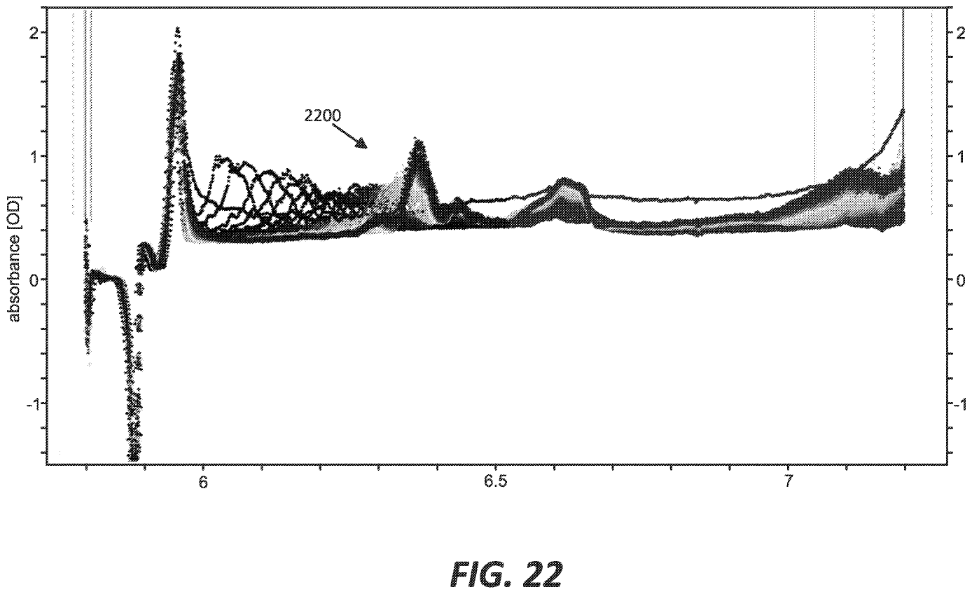

FIG. 22 illustrates empirical data 2200 of light absorption (y-axis) measured across a length of a container (x-axis) during centrifugation by the centrifuge 100. The empirical data 2200 is measured from an experiment that used a sample of liposomes having a total volume of 7 μL of which 5 μL included liposomes having an empty payload and 2 μL included liposomes having a drug payload. The sample of liposomes was mixed with a density gradient solution 202 having 10% sucrose as the density gradient forming material. The experiment was run by rotating the rotor 106 at a constant speed of 40 krpm and at a constant temperature of 20 °C for a runtime of 42 hours. The light absorption is measured at a wavelength of 230 nm. The empirical data 1100 is based on a total of 250 scans measured every 10 minutes over the 42 hour duration of the experiment, with every 5th scan (i.e., one plot every 50 minutes) being shown in the empirical data 2200 of FIG. 22.

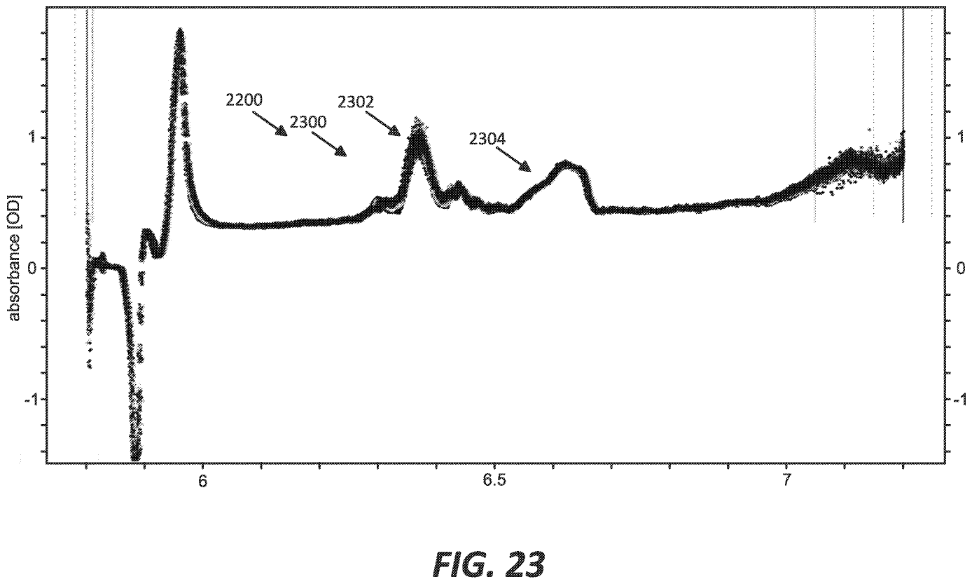

FIG. 23 illustrates a portion 2300 of the empirical data 2200 of FIG. 22. The portion 2300 includes scans that are measured toward an end of the experiment after equilibrium has been attained inside the container. For example, the portion 2300 includes light absorption scans measured during hours 36-42 of the experiment. Every scan during this time period is shown in FIG. 23, which corresponds to one plot every 10 minutes.

FIG. 23 shows that when the sample of liposomes and the density gradient solution 202 have attained equilibrium inside the container, there two distinct specifies in the liposome sample: a first species 2302 that occurs at about 6.3 cm along the length of the container, and a second species 2304 that occurs at about 6.6 cm along the length of the container. The first species 2302 corresponds to liposomes having a full or partially full payload, and the second species 2304 corresponds to liposomes having an empty payload.

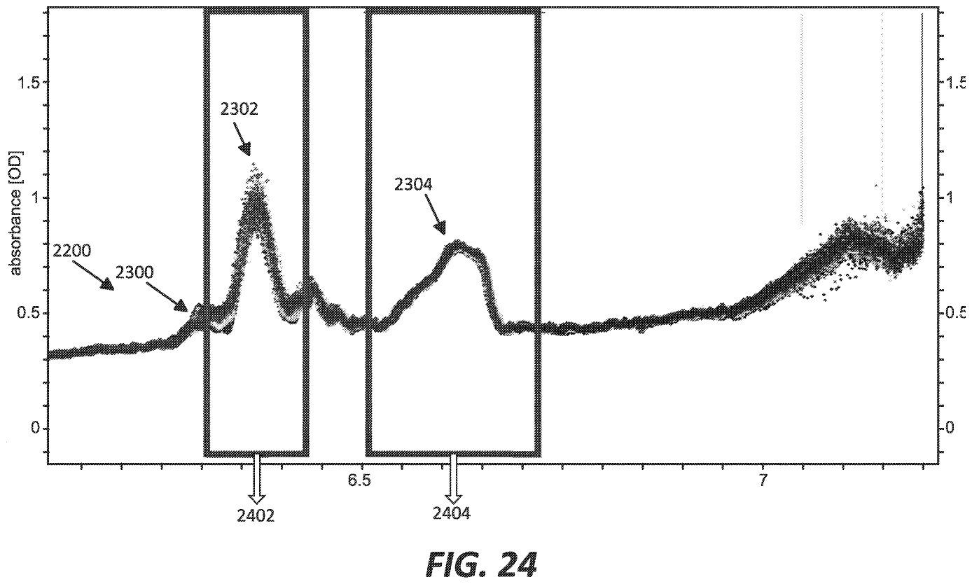

FIG. 24 illustrates segmentation of the portion 2300 of the empirical data 2200 from FIG. 23. As shown in FIG. 24, a first demarcating box 2402 is drawn around the first species 2302, and a second demarcating box 2404 is drawn around the second species 2304.

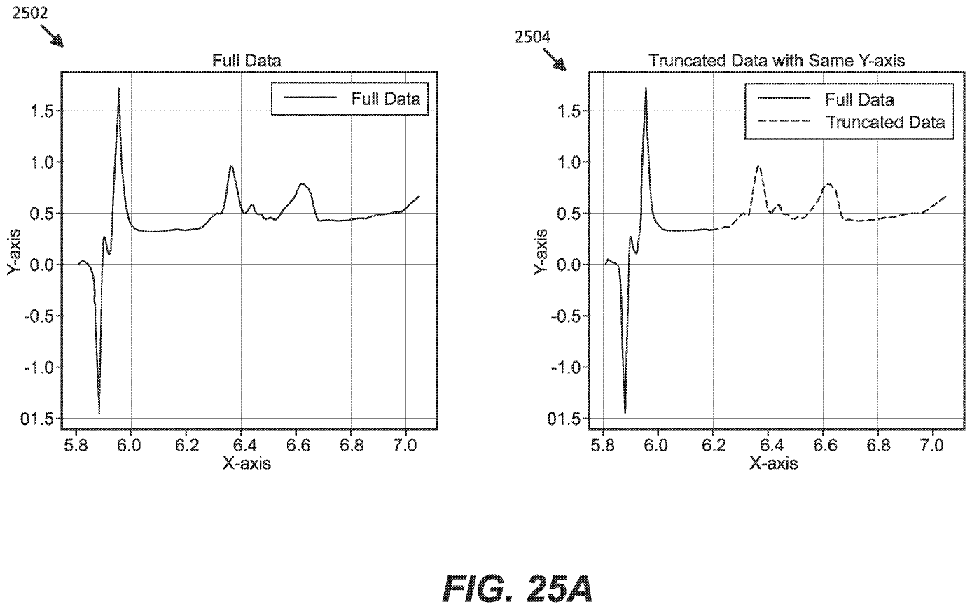

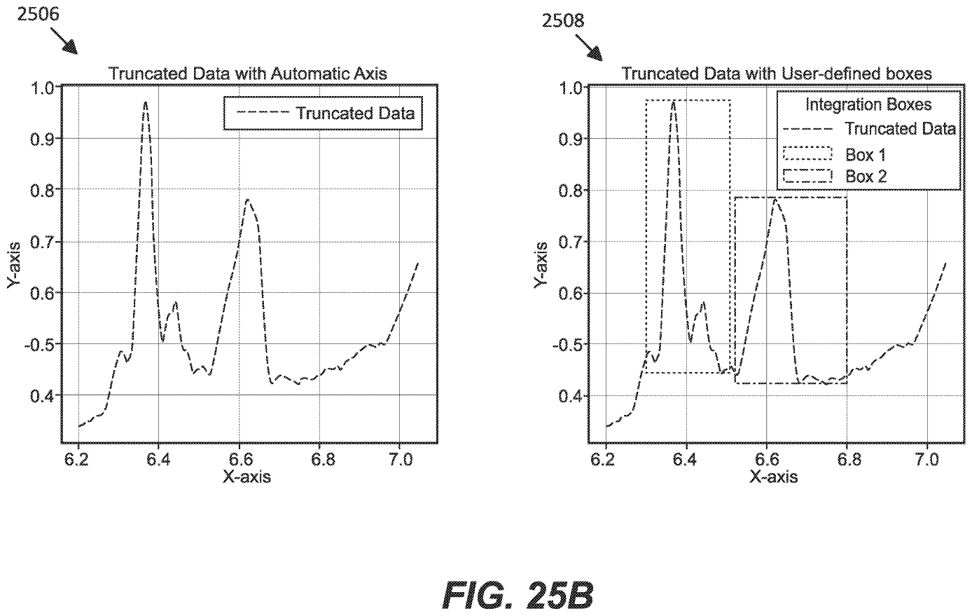

FIGS. 25A and 25B illustrate examples of performance of the operations 2108-2116 of the method 2100 on the empirical data 2200. FIG. 25A includes a chart 2502 of the light absorption data after averaging is completed in operation 2108. FIG. 25A further includes a chart 2504 of the light absorption data after segmenting is completed in operation 211. FIG. 25B includes a chart 2506 showing the light absorption data after truncating is completed in operation 2112. FIG. 25B further includes a chart 2508 showing demarcating boxes drawn around the first species 2302 and the second species 2304 identified in the liposome data in operation 2114.

Table 2 provides metrics calculated in operation 2116 for the first demarcating box 2402 drawn around the first species 2302, and the second demarcating box 2404 drawn around the second species 2304. The first demarcating box 2402 has an area-under-curve of 1.22*10\hat{ }(−1) which represents 44.82% of the total area-under-curve. Thus, in this illustrative example, 44.82% of the sample of liposomes analyzed in accordance with the method 2100 includes drug loaded liposomes. The second demarcating box 2404 has an area-under-curve of 1.50*10\hat{ }(−1) which represents 55.14% of the total area-under-curve. Thus, in this illustrative example, 55.14% of the sample of liposomes includes empty liposomes.

TABLE 2

| | Wavelength | | | | | % |
|---|---|---|---|---|---|---|
| Experiment | (nm) | Box# | Center | Width | Area | Total |
| Empty + | 230 | 1 | 6.405 | 0.210 | 1.22E−01 | 44.82 |
| Drug Loaded | | | | | | |
| Liposomes | | | | | | |
| Empty + | 230 | 2 | 6.660 | 0.280 | 1.50E−01 | 55.14 |
| Drug Loaded | | | | | | |
| Liposomes | | | | | | |

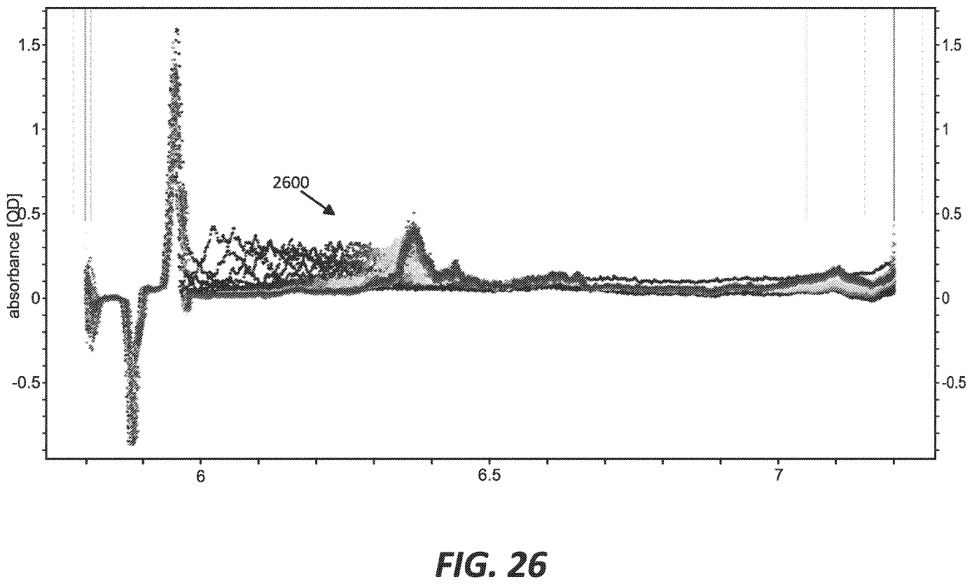

FIG. 26 illustrates empirical data 2600 of light absorption (y-axis) measured across a length of a container (x-axis) during centrifugation by the centrifuge 100. The empirical data 2200 is measured from the same experiment that collected the empirical data 2200 shown in FIG. 22. For example, the empirical data 2600 is from a sample of 5 μL liposomes having empty payload and 2 μL liposomes having drug payload, and mixed with a density gradient solution having 10% sucrose as the density gradient forming material. The rotor 106 is rotated at a constant speed of 40 krpm and at a constant temperature of 20 °C for a runtime of 42 hours. The empirical data 2600 has a total of 250 scans measured every 10 minutes over the 42 hours of the experiment, with every 5th scan (i.e., one plot every 50 minutes) being shown.

The empirical data 2600 differs from the empirical data 2200 shown in FIG. 22 in that the light absorption is measured at a wavelength of 490 nm (instead of 230 nm in FIG. 22). As shown in FIG. 26, only one distinct species is visible in the empirical data 2600. This is because measuring absorbance at 490 nm monitors the drug (e.g., doxorubicin) directly. A comparison of the empirical data in FIG. 22 versus that in FIG. 26 indicates that at equilibrium, the single distinct species seen in FIG. 26 corresponds to the left side species seen in FIG. 22.

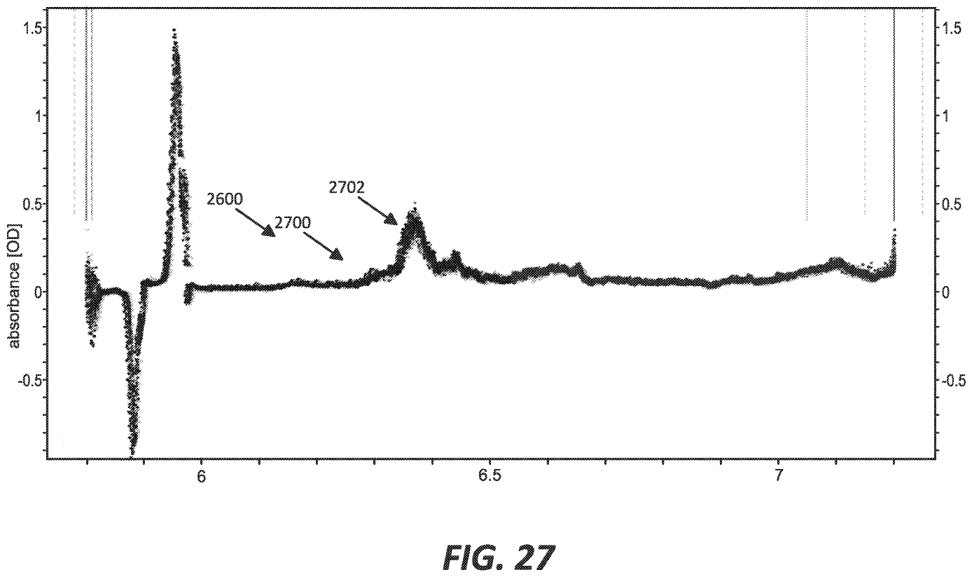

FIG. 27 illustrates a portion 2700 of the empirical data 2600 of FIG. 26. The portion 2700 includes scans that are measured toward an end of the experiment after equilibrium has been attained inside the container. For example, the portion 2700 includes light absorption scans measured during hours 36-42 of the experiment. Every scan during this time period is shown in FIG. 27, which corresponds to one plot every 10 minutes.

FIG. 27 shows that when the sample of liposomes has attained equilibrium inside the container, a single species 2702 is visible at about 6.3 cm along the length of the container under a wavelength of 490 nm. The second species 2304 that is visible in the empirical data of FIG. 23 captured under a wavelength of 230 nm is no longer prominent. The single species 2702 corresponds to liposomes having a full or partially full payload.

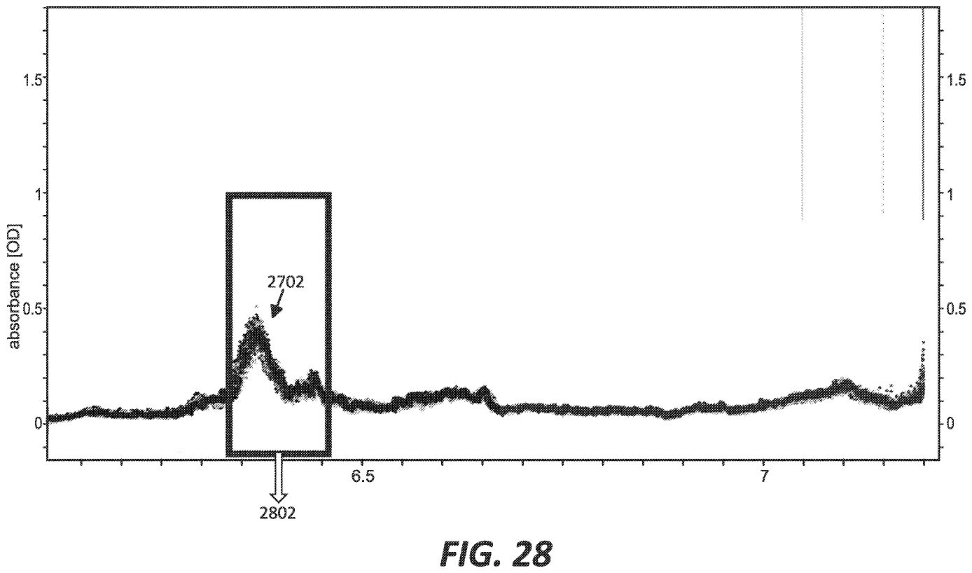

FIG. 28 illustrates segmentation of the portion 2700 of the empirical data 2600 from FIG. 27. In this example, a single demarcating box 2802 is drawn around the single species 2702.

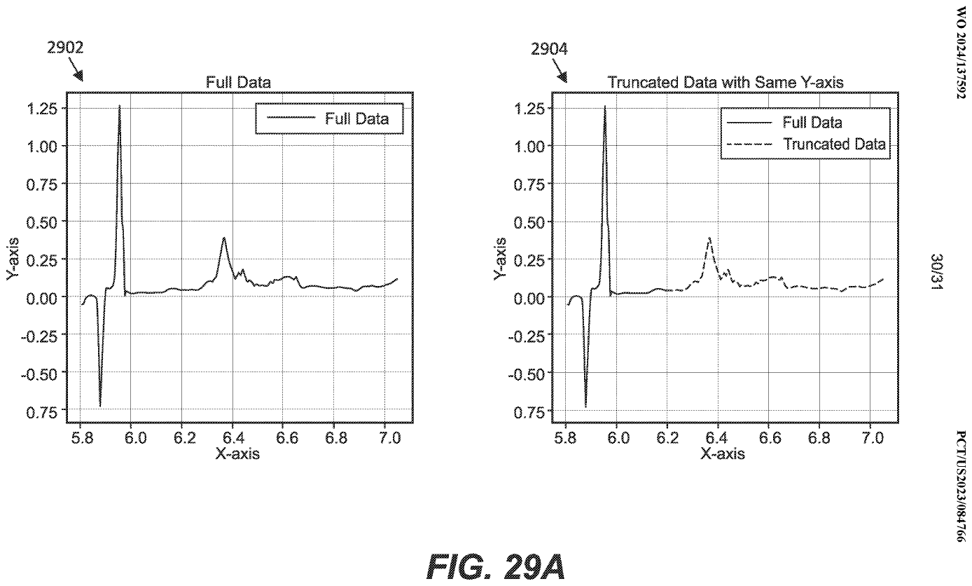

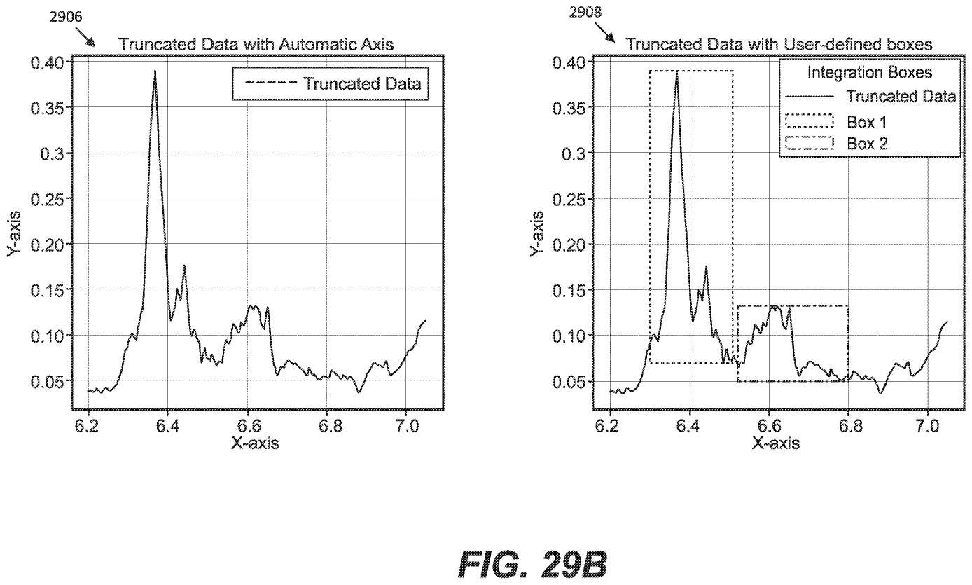

FIGS. 29A and 29B illustrate examples of performance of the operations 2108-2116 of the method 2100 on the empirical data 2600. FIG. 29A includes a chart 2902 of the light absorption data after averaging is completed in operation 2108. FIG. 29A further includes a chart 2904 of the light absorption data after segmenting is completed in operation 2110. FIG. 29B includes a chart 2906 showing the light absorption data after truncating is completed in operation 2112. FIG. 29B further includes a chart 2908 showing a demarcating box drawn around the single species 2702 identified in the liposome data in operation 2114, and another demarcating box drawn around the location where the second species 2304 occurs.

The various embodiments described above are provided by way of illustration only and should not be construed to be limiting in any way. Various modifications can be made to the embodiments described above without departing from the true spirit and scope of the disclosure.

Embodiments of the disclosure can be described with reference to the following numbered clauses, with preferred features laid out in the dependent clauses:
1. A system for analyzing a sample of lipid based nanoparticles designed for carrying a payload, the system comprising:
   a processing circuitry having one or more non-transitory computer readable storage media storing instructions which, when executed by the processing circuitry, cause the processing circuitry to:
      rotate a rotor holding at least one container, the at least one container having a density gradient forming material and the sample of lipid based nanoparticles;
      measure light absorption by the sample of lipid based nanoparticles in the at least one container while rotating the rotor; and
      assess a magnitude of the payload carried in the sample of lipid based nanoparticles based on the light absorption.
2. The system of clause 1, wherein the one or more non-transitory computer readable storage media store additional instructions which, when executed by the processing circuitry, further cause the processing circuitry to:
   rotate the rotor at a preset rotor speed in a range from 3,000 rpm to 60,000 rpm.
3. The system of clause 1 or 2, wherein the one or more non-transitory computer readable storage media store additional instructions which, when executed by the processing circuitry, further cause the processing circuitry to:
   rotate the rotor for a preset run time in a range from 1 to 72 hours.
4. The system of clause 1, wherein the one or more non-transitory computer readable storage media store additional instructions which, when executed by the processing circuitry, further cause the processing circuitry to:
   measure a density gradient based on light interference.
5. The system of clause 4, wherein the one or more non-transitory computer readable storage media store additional instructions which, when executed by the processing circuitry, further cause the processing circuitry to:
   increase a speed of rotation of the rotor to increase a slope of the density gradient.
6. The system of clause 4, wherein the one or more non-transitory computer readable storage media store additional instructions which, when executed by the processing circuitry, further cause the processing circuitry to:
   decrease a speed of rotation of the rotor to decrease a slope of the density gradient.
7. The system of clause 4, wherein the one or more non-transitory computer readable storage media store additional instructions which, when executed by the processing circuitry, further cause the processing circuitry to:
   increase a speed of rotation of the rotor to increase a slope of the density gradient based on at least one of the light absorption and the light interference; and
   decrease the speed of rotation of the rotor to decrease the slope of the density gradient based on at least one of the light absorption and the light interference.
8. The system of clause 1, wherein the density gradient forming material includes one or more of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.
9. A method of analyzing a sample of lipid based nanoparticles, the method comprising:
   providing a density gradient forming material;
   operating a centrifuge to rotate a rotor about an axis of rotation at a preset rotor speed to utilize a density gradient in a container having the density gradient forming material and the sample of lipid based nanoparticles;
   measuring light absorption by the sample of lipid based nanoparticles in the container; and
   determining a ratio of the lipid based nanoparticles having a full payload versus an empty or partially full payload based on the light absorption.
10. The method of clause 9, wherein the density gradient forming material includes at least one of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.
11. The method of clause 9, rotating the rotor at a preset rotor speed in a range from 3,000 rpm to 60,000 rpm.
12. The method of clause 9, further comprising:
   measuring a density gradient in the container based on light interference.
13. The method of clause 12, further comprising:
   increasing a speed of rotation of the rotor to increase a slope of the density gradient for detecting a broader range of densities for determining the ratio of the lipid based nanoparticles.
14. The method of clause 12, further comprising:
   decreasing a speed of rotation of the rotor to decrease a slope of the density gradient for detecting a higher resolution of densities for determining the ratio of the lipid based nanoparticles.
15. The method of clause 12, further comprising:
   increasing a speed of rotation of the rotor to increase a slope of the density gradient based on at least one of the light absorption and the light interference; and
   decreasing the speed of rotation of the rotor to decrease the slope of the density gradient based on at least one of the light absorption and the light interference.
16. A centrifuge for providing quality control of a sample of lipid based nanoparticles, the centrifuge comprising:
   a rotor for holding the sample of lipid based nanoparticles;
   an optical system for measuring light absorption by the sample of lipid based nanoparticles while the rotor rotates; and
   one or more non-transitory computer readable storage media programmed to analyze the light absorption of the sample of lipid based nanoparticles when the sample of lipid based nanoparticles is suspended in a density gradient.
17. The centrifuge of clause 16, wherein the one or more non-transitory computer readable storage media are further programmed to determine a ratio of the lipid based nanoparticles having a full payload versus an empty or partially full payload.
18. The centrifuge of clause 16, wherein the sample of lipid based nanoparticles includes a density gradient forming material including at least one of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.
19. The centrifuge of clause 16, wherein the one or more non-transitory computer readable storage media are further programmed to measure the density gradient based on light interference of the sample of lipid based nanoparticles suspended in the density gradient.
20. The centrifuge of clause 16, wherein the one or more non-transitory computer readable storage media are further programmed to rotate the rotor at a preset rotor speed for a preset run time.
21. The centrifuge of clause 20, wherein the preset rotor speed is in a range from 3,000 rpm to 60,000 rpm.
22. The centrifuge of clause 20 or 21, wherein the preset run time is in a range from 1 hour to 72 hours.
23. A system for analyzing a sample of lipid based nanoparticles, the system comprising:
   a processing circuitry having one or more non-transitory computer readable storage media storing instructions which, when executed by the processing circuitry, cause the processing circuitry to:
      rotate a rotor about an axis of rotation at a preset rotor speed, the rotor holding at least one container having a density gradient forming material added to the sample of lipid based nanoparticles;
      measure light absorption by the sample of lipid based nanoparticles in the at least one container; and
      determine a ratio of the lipid based nanoparticles having a full payload versus an empty or partially full payload based on the light absorption.
24. The system of clause 23, wherein the preset rotor speed is in a range from 3,000 rpm to 60,000 rpm.
25. The system of clause 23 or 24, wherein the rotor is rotated in a range from 1 hour to 72 hours.
26. The system of clause 23, wherein the one or more non-transitory computer readable storage media store additional instructions which, when executed by the processing circuitry, further cause the processing circuitry to:
   measure a density gradient in the at least one container based on light interference.
27. A system for analyzing a sample of lipid based nanoparticles, the system comprising:
   a processing circuitry having one or more non-transitory computer readable storage media storing instructions which, when executed by the processing circuitry, cause the processing circuitry to:
      rotate a rotor holding at least one container, the at least one container having a density gradient forming material and the sample of lipid based nanoparticles;
      measure a density gradient in the at least on container;
      measure positions of the lipid based nanoparticles relative to the density gradient; and
      assess a magnitude of a payload of the lipid based nanoparticles based on the positions of the lipid based nanoparticles relative to the density gradient.
28. A method for density-based separation of lipid based nanoparticles by centrifugation, the method comprising:
   receiving a container having a solution and lipid based nanoparticles;
   applying a centrifugal force to the container to cause the lipid based nanoparticles to displace and form at least one detectable grouping within the container;
   and measuring the position of the at least one detectable grouping of lipid based nanoparticles.
29. The method of clause 28, wherein applying the centrifugal force to the container also causes the solution to form a density gradient.
30. The method of clause 28, wherein the position of the at least one grouping of lipid based nanoparticles is measured using light absorption data.
31. The method of clause 28, wherein the at least detectable grouping of lipid based nanoparticles includes lipid based nanoparticles having a similar density.
32. The method of clause 28, wherein the at least one grouping of lipid based nanoparticles includes lipid based nanoparticles having a similar payload, the payload being full, partially empty, or empty.
33. The method of clause 32, further comprising:
   determining a ratio of full, partially empty, or empty lipid based nanoparticles.
34. The method of clause 28, wherein the position of the at least one grouping of lipid based nanoparticles is measured relative to a radial position inside a rotor chamber.
35. The method of clause 28, wherein the position of the at least one grouping of lipid based nanoparticles is measured relative to a density gradient.
36. The method of clause 28, wherein the solution includes at least one of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.
37. The method of clause 28, wherein the centrifugal force is applied in a range of 3,000 rpm to 60,000 rpm for 1 to 72 hours.
38. The method of clause 28, wherein the centrifugal force is applied in multiple stages, each stage having a different rotor speed run for a predetermined period of time.

1. A method of analyzing a sample of lipid based nanoparticles, the method comprising:
providing a density gradient forming material;
operating a centrifuge to rotate a rotor about an axis of rotation at a preset rotor speed to utilize a density gradient in a container having the density gradient forming material and the sample of lipid based nanoparticles;
measuring light absorption by the sample of lipid based nanoparticles in the container; and
determining a ratio of the lipid based nanoparticles having a full payload versus an empty or partially full payload based on the light absorption.

2. The method of claim 1, wherein the density gradient forming material includes at least one of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.

3. The method of claim 1, rotating the rotor at a preset rotor speed in a range from 3,000 rpm to 60,000 rpm.

4. The method of claim 1, further comprising:
measuring a density gradient in the container based on light interference.

5. The method of claim 4, further comprising:
increasing a speed of rotation of the rotor to increase a slope of the density gradient for detecting a broader range of densities for determining the ratio of the lipid based nanoparticles.

6. The method of claim 4, further comprising:
decreasing a speed of rotation of the rotor to decrease a slope of the density gradient for detecting a higher resolution of densities for determining the ratio of the lipid based nanoparticles.

7. The method of claim 4, further comprising:
increasing a speed of rotation of the rotor to increase a slope of the density gradient based on at least one of the light absorption and the light interference; and
decreasing the speed of rotation of the rotor to decrease the slope of the density gradient based on at least one of the light absorption and the light interference.

8. A system for analyzing a sample of lipid based nanoparticles designed for carrying a payload, the system comprising:
a processing circuitry having one or more non-transitory computer readable storage media storing instructions which, when executed by the processing circuitry, cause the processing circuitry to:
rotate a rotor holding at least one container, the at least one container having a density gradient forming material and the sample of lipid based nanoparticles;
measure light absorption by the sample of lipid based nanoparticles in the at least one container while rotating the rotor; and
assess a magnitude of the payload carried in the sample of lipid based nanoparticles based on the light absorption.

9. The system of claim 8, wherein the one or more non-transitory computer readable storage media store additional instructions which, when executed by the processing circuitry, further cause the processing circuitry to:
rotate the rotor at a preset rotor speed in a range from 3,000 rpm to 60,000 rpm.

10. The system of claim 8, wherein the one or more non-transitory computer readable storage media store additional instructions which, when executed by the processing circuitry, further cause the processing circuitry to:
rotate the rotor for a preset run time in a range from 1 to 72 hours.

11. The system of claim 8, wherein the one or more non-transitory computer readable storage media store additional instructions which, when executed by the processing circuitry, further cause the processing circuitry to:
measure a density gradient based on light interference.

12. The system of claim 11, wherein the one or more non-transitory computer readable storage media store additional instructions which, when executed by the processing circuitry, further cause the processing circuitry to:
increase a speed of rotation of the rotor to increase a slope of the density gradient.

13. The system of claim 11, wherein the one or more non-transitory computer readable storage media store additional instructions which, when executed by the processing circuitry, further cause the processing circuitry to:
decrease a speed of rotation of the rotor to decrease a slope of the density gradient.

14. The system of claim 11, wherein the one or more non-transitory computer readable storage media store additional instructions which, when executed by the processing circuitry, further cause the processing circuitry to:
increase a speed of rotation of the rotor to increase a slope of the density gradient based on at least one of the light absorption and the light interference; and
decrease the speed of rotation of the rotor to decrease the slope of the density gradient based on at least one of the light absorption and the light interference.

15. The system of claim 8, wherein the density gradient forming material includes at least one of cesium chloride, cesium sulfate, cesium acetate, sodium iodide, sodium bromide, potassium tartrate, potassium bromide, iodixanol, Percoll®, Percoll Plus®, sucrose, glucose, glycerol, dextran, trehalose, epichlorohydrin, Ficoll®, and Ficoll-Paque®.
